(19) United States
(12) Patent Application Publication
(10) Pub. No.: US 2008/0092926 A1
(43) Pub. Date: Apr. 24, 2008

(54) CLEANING APPARATUS WITH DISPOSABLE ELEMENTS AND METHODS OF CLEANING

(76) Inventors: James F. Kimball, Greenfield, WI (US); Eric J. Minor, Lake Villa, IL (US); Steven C. Shirley, Racine, WI (US); Philip M. Anthony, Chicago, IL (US); William E. Venth, Chicago, IL (US); Eric J. Schmidt, Park Ridge, IL (US); Aaron B. Eiger, Chicago, IL (US)

Correspondence Address: S.C. JOHNSON & SON, INC., 1525 HOWE STREET, RACINE, WI, 53403-2236, US

(21) Appl. No.: 11/551,819

(22) Filed: Oct. 23, 2006

(51) Int. Cl. B08B 3/00

(52) U.S. Cl. 134/26

(57) ABSTRACT

A method of and system for cleaning a surface applies a first fluid to the surface by feeding the first fluid from a unitary cleaning receptacle removably secured to a cleaning unit and moves the unitary cleaning receptacle relative to the cleaning unit to agitate the cleaning solution. A second fluid is applied from the unitary cleaning receptacle to the surface and at least a portion of the first fluid and at least a portion of the second fluid are captured in a recovery compartment of the unitary cleaning receptacle

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to cleaning devices and methods, and more particularly to cleaning devices and methods of cleaning that utilize disposable elements.

2. Description of the Background of the Invention

Cleaning apparatus have long been known that utilize disposable bags or other containers for collection of debris. One such type of device comprises a sweeper that utilizes wheel-driven brushes to direct debris into a collection chamber. A further type of cleaning device utilizes a motor and impeller to develop a vacuum that is directed by a hose to an area to be cleaned. This type of device can be categorized as a dry-type cleaner, which is intended only to pick up dry debris, or a wet/dry-type of cleaner, which is capable of picking up wet as well as dry substances.

Still further cleaning devices have been developed that allow a user to fill an on-board reservoir with a cleaning liquid (e.g., water or a solution of water and a cleaning composition), deposit the cleaning liquid on a surface to be cleaned, agitate the deposited liquid on the surface, and remove the liquid and debris entrained in the cleaning liquid by means of a suction action such that the liquid and debris are deposited into a collection chamber. Upon the completion of a cleaning operation, the collection chamber may be removed from the cleaning device, emptied, optionally rinsed or otherwise cleaned out, and returned to a mounting position on the cleaning device. An alternative device utilizes a disposable bag carried in a housing of the device. Liquid and debris are deposited into the bag during a cleaning operation, whereupon the bag and the retrieved liquid and debris are removed from the housing, disposed of, and a new, empty bag is replaced in the housing.

Such types of cleaning devices are complex and difficult to operate effectively. Often, spillage of cleaning liquid and/or debris occurs, particularly during transport of the collection chamber or other container. Also, the user must often mix solution components to obtain the cleaning liquid, leading to the possibility that chemicals may be mixed incorrectly, and/or that chemicals may be undesirably exposed to the environment. Further, such devices require a great deal of user intervention because of the need to undertake numerous steps in order to clean even a small area. The user must not only be present during operation of the device at all times, but must actively control the device to accomplish proper cleaning. Such devices are also large and cumbersome, and do not lend themselves readily to portable operation.

The normal process of manual cleaning by an untrained person, such as a consumer, also introduces variability that inhibits proper carpet cleaning. Too much cleaning solution is often times deposited on the carpet, which leads to significant absorption of cleaning and liquid deep into the carpet. Additionally, the untrained cleaner often does not rinse the area to remove the residual cleaner and detergent. In such a case, the cleaned area often looks good at first, but spots begin to reappear, due to the attraction of dust and dirt to leftover surfactants from the cleaning solution. Spots also begin to reappear due to wicking of the liquid from deep within the carpet up to the surface, wherein sometimes soil comes with the liquid. In addition, stains and excess cleaning detergent that have wicked deep into the carpet and carpet backing may emit odors for several months following treatment if they are not recovered by a cleaning device.

### SUMMARY OF THE INVENTION

According to one aspect of the present invention, a method of cleaning a surface applies a first fluid to the surface by feeding the first fluid from a unitary cleaning receptacle removably secured to a cleaning unit and moves the unitary cleaning receptacle relative to the cleaning unit to agitate the cleaning solution. A second fluid is applied from the unitary cleaning receptacle to the surface and at least a portion of the first fluid and at least a portion of the second fluid are captured in a recovery compartment of the unitary cleaning receptacle.

According to another aspect of the present invention, a cleaning receptacle includes a first non-expandable compartment for containing a first fluid, a second non-expandable compartment for containing a second fluid, and a third non-expandable compartment for receiving first and second fluids that are recovered from a surface. The second compartment is integral with the first compartment and the cleaning receptacle is removably mounted on the cleaning unit.

According to yet another aspect of the present invention, a cleaning receptacle comprises a first compartment for containing a first fluid, a second compartment for containing a second fluid, wherein the second compartment shares a rigid common wall with the first compartment, and a third compartment for receiving recovered first and second fluid, wherein the third compartment shares a rigid common wall with the second compartment.

According to a still further aspect of the present invention, a cleaning unit includes a source of vacuum and a unitary cleaning receptacle defining first, second, and third compartments, each integral with the cleaning receptacle. The cleaning receptacle is removably mounted on the cleaning unit such that the unitary cleaning receptacle is in communication with the source of vacuum to draw fluids and dirt from a surface into the third compartment.

In accordance with yet another aspect of the present invention, a cleaning receptacle includes a first compartment for containing a fluid, a second compartment for receiving recovered fluid, wherein the second compartment is integral with the first compartment, and an indicator disposed on the cleaning receptacle and configured to indicate the type of cleaning receptacle.

According to another aspect of the present invention, a system for cleaning surfaces comprises a cleaning unit and a first cleaning receptacle defining at least two compartments that are integral with the first receptacle, wherein the first cleaning receptacle is removably mounted within the cleaning unit and wherein one of the at least two compartments includes a first fluid specific to cleaning a first predetermined set of surface conditions. The system further includes a second cleaning receptacle defining at least two integral compartments that are integral with the second receptacle, wherein the second cleaning receptacle is removably mounted within the cleaning unit and wherein one of the at least two compartments in the second cleaning receptacle includes a second fluid specific to cleaning a second predetermined set of surface conditions different from the first set of surface conditions.

According to a further aspect of the present invention, a cleaning receptacle comprises first walls forming a receptacle body having a compartment for receipt of a cleaning solution therein, the walls further including at least one second wall defining an aperture configured to accept a member of a vacuum cleaning apparatus therein.

According to yet another aspect of the present invention, a method of cleaning a surface includes the steps of applying a first fluid to the surface by feeding the first fluid from a cleaning receptacle removably secured to a cleaning unit and moving the cleaning receptacle relative to the cleaning unit to agitate the cleaning solution. A second fluid is applied to the surface and at least a portion of the first fluid and at least a portion of the second fluid are captured in a recovery compartment associated with the cleaning receptacle. The cleaning receptacle is removed from the cleaning unit and the cleaning receptacle is replaced with a further unitary cleaning receptacle.

According to yet another aspect, a cleaning receptacle includes a first compartment for containing a first fluid, a second compartment for containing a second fluid, wherein the second compartment is connected by a web to the first compartment, and a third compartment for receiving recovered first and second fluid.

Other aspects and advantages of the present invention will become apparent upon consideration of the following detailed description.

### BRIEF DESCRIPTION OF THE DRAWINGS

FIG. 1 is an isometric view of a first embodiment of a cleaning device in accordance with the present invention;

FIG. 2 is a front elevational view of the device of FIG. 1;

FIG. 3 is an exploded isometric view of the embodiment of FIG. 1 illustrating the cleaning receptacle separate from the balance of the cleaning device;

FIGS. 4, 5, and 6 are sectional views taken generally along the lines 4-4, 5-5, and 6-6, respectively, of FIG. 2;

FIG. 7 is a sectional view taken generally along the lines 7-7 of FIG. 4;

FIG. 8 is a sectional view taken generally along the lines 8-8 of FIG. 5;

FIG. 9 is a sectional view taken generally along the lines 9-9 of FIG. 8;

FIGS. 9A and 9B are top and bottom isometric views, respectively, illustrating a chassis assembly disposed in the chassis housing of FIG. 1;

FIGS. 9C and 9D are top isometric views of the chassis assembly with portions removed for clarity and illustrating the operation of the cleaning receptacle clamping assembly thereof;

FIG. 9E is a view similar to FIGS. 9C and 9D with further portions removed for clarity;

FIG. 10 is a top isometric view of the cleaning receptacle of FIG. 3;

FIG. 11 is a plan view of the cleaning receptacle of FIG. 3;

FIG. 12 is a bottom elevational view of the cleaning receptacle of FIG. 3;

FIG. 13 is a sectional view taken generally along the lines 13-13 of FIG. 11;

FIG. 14 is a sectional view taken generally along the lines 14-14 of FIG. 12;

FIG. 15 is a top exploded isometric view of the cleaning receptacle of FIG. 3 illustrating a cover of the cleaning receptacle separate from the balance thereof and viewed from a first vantage point;

FIG. 16 is a top exploded isometric view of the cleaning receptacle of FIG. 3 illustrating various components separate from the balance thereof and viewed from a second vantage point generally opposite the first vantage point of FIG. 15;

FIG. 16 A is a bottom isometric view of an insert retained within the cleaning receptacle of FIG. 3;

FIG. 17 is a plan view of the cleaning receptacle of FIG. 3 with all components removed therefrom except the valves;

FIG. 18 is a bottom exploded isometric view of the cleaning receptacle of FIG. 3 illustrating the cover of the cleaning receptacle separate from the balance thereof and viewed from a third vantage point;

FIG. 19 is a bottom exploded trimetric view of the cleaning receptacle of FIG. 3 illustrating the cover of the cleaning receptacle separate from the balance thereof and viewed from a fourth vantage point different than the third vantage point of FIG. 18;

FIG. 20 is a top isometric view of a further embodiment of a cleaning receptacle illustrating a cover in an open position with internal components removed for clarity;

FIG. 21 is an enlarged fragmentary view of a portion of the cleaning receptacle of FIG. 20 illustrating structure for retaining the cover in a closed position;

FIG. 22 is an isometric view of structure insertable into the cleaning receptacle of FIG. 20 and defining compartments for receipt of fluids therein;

FIG. 23 is a top isometric view of the cleaning receptacle of FIG. 20 illustrating a cover in an open position and wherein the structure of FIG. 22 is inserted therein;

FIG. 24 is a top isometric view of the cleaning receptacle of FIG. 23 illustrating the cover in a closed position;

FIG. 25 is a fragmentary, sectional, and diagrammatic view illustrating the communication between the structure of FIG. 22 and the cleaning receptacle of FIG. 20;

FIG. 26 is an isometric view of further structure insertable into the cleaning receptacle of FIG. 20 and defining compartments for receipt of fluids therein;

FIG. 27 is an isometric view of yet other structure insertable into the cleaning receptacle of FIG. 20 and defining compartments for receipt of fluids therein

FIGS. 28A-28C are fragmentary, sectional, and diagrammatic views illustrating the steps of piercing any of the structures of FIGS. 22, 26, or 27 to permit the flow of fluids therefrom using a first piercing arrangement;

FIGS. 29 and 30 are fragmentary, isometric top and bottom views, respectively, illustrating portions of a cover that may be used in place of the cover of FIGS. 23 and 24;

FIGS. 31 and 32 are sectional views taken generally along the lines 31-31 of FIG. 29 illustrating the process of piercing any of the structures of FIGS. 22, 26, or 27 to permit the flow of fluids therefrom using a second piercing arrangement carried by the cover of FIGS. 29 and 30;

FIGS. 33A and 33 B are bottom elevational views taken generally along the view lines of FIG. 31 of examples of spikes that may be used in the embodiment of FIGS. 31 and 32;

FIG. 34 is an exploded fragmentary view of another embodiment of a cleaning device according to the present invention;

FIG. 35 is an isometric view of the cleaning receptacle of FIG. 34 taken from a vantage point generally opposite to the vantage point of FIG. 34;

FIG. 35A is an isometric view of the cleaning receptacle of FIG. 34 taken from a vantage point generally opposite to the vantage point of FIG. 34 and illustrating activation of the cleaning receptacle;

FIG. 36 is an exploded isometric view of the cleaning receptacle of FIG. 35 illustrating interior structures thereof;

FIG. 37 is a bottom elevational view of a top portion of the cleaning receptacle of FIG. 35;

FIG. 38 is a plan view of a bottom portion of the cleaning receptacle of FIG. 35; and

FIG. 39 is a side elevational view of the cleaning receptacle of FIG. 35 illustrating interior structures thereof in phantom.

### DETAILED DESCRIPTION OF THE EMBODIMENTS

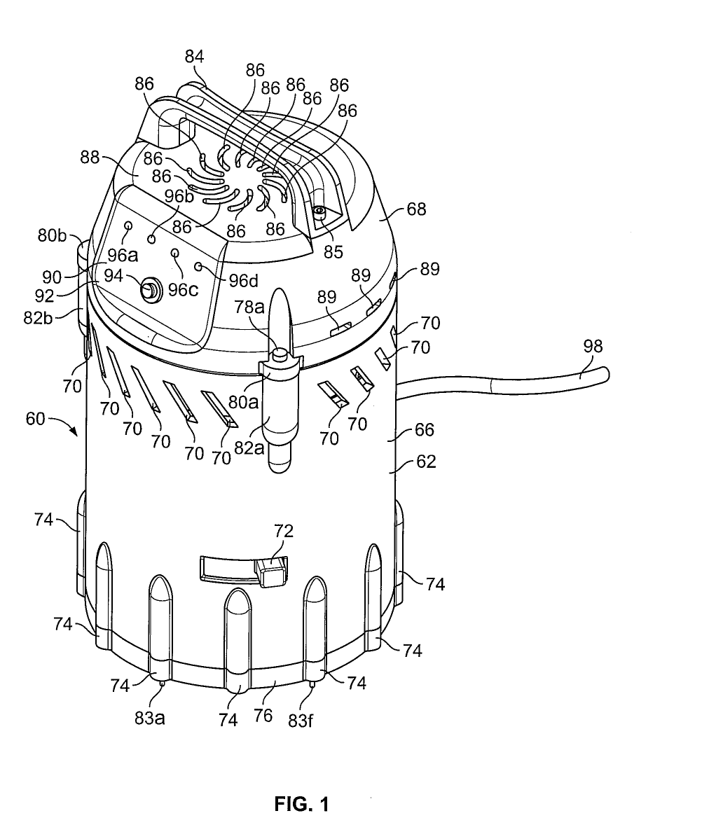

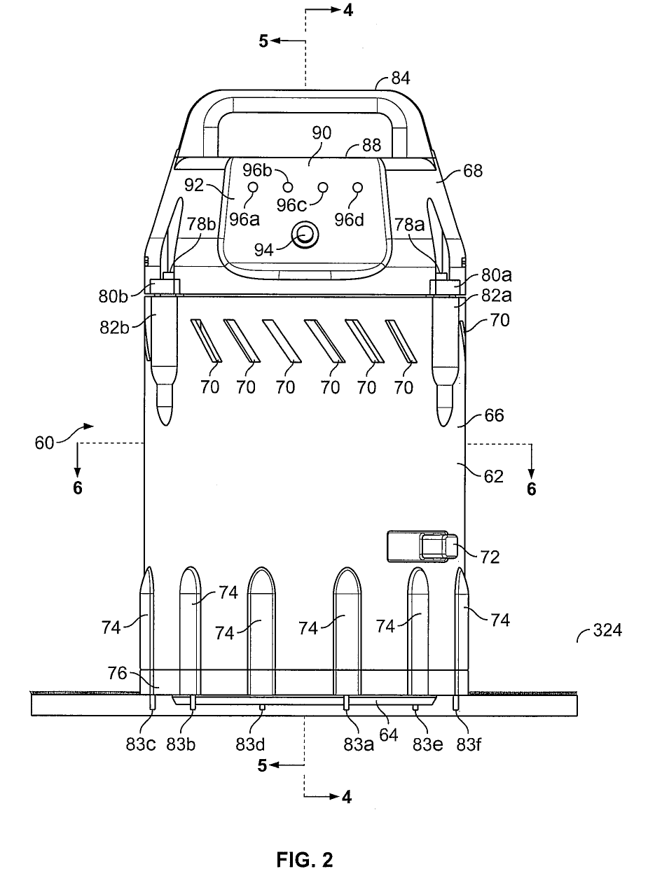

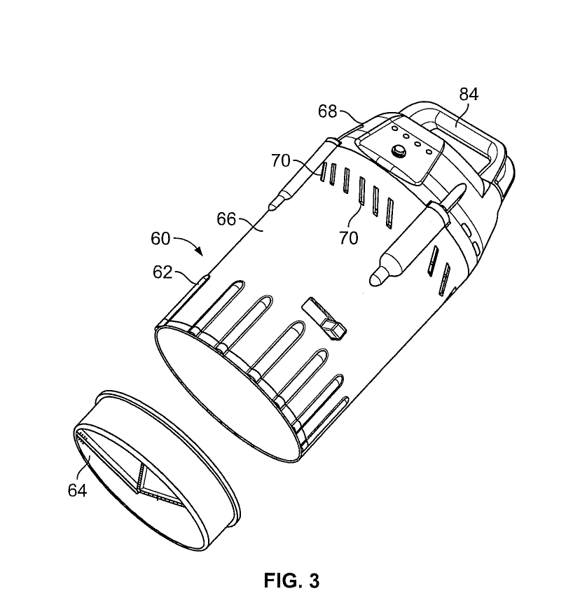

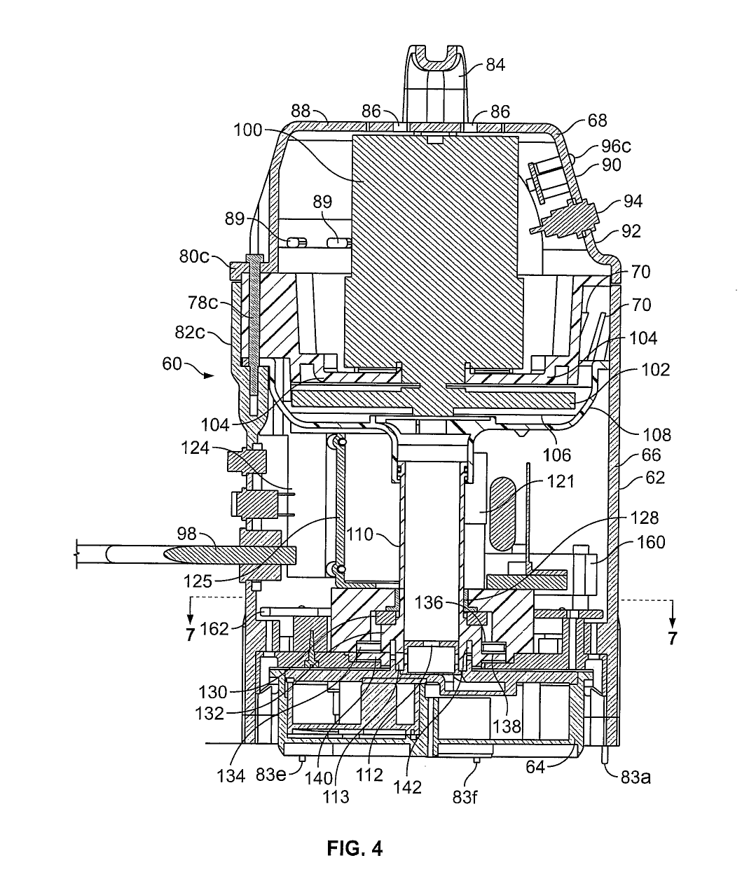

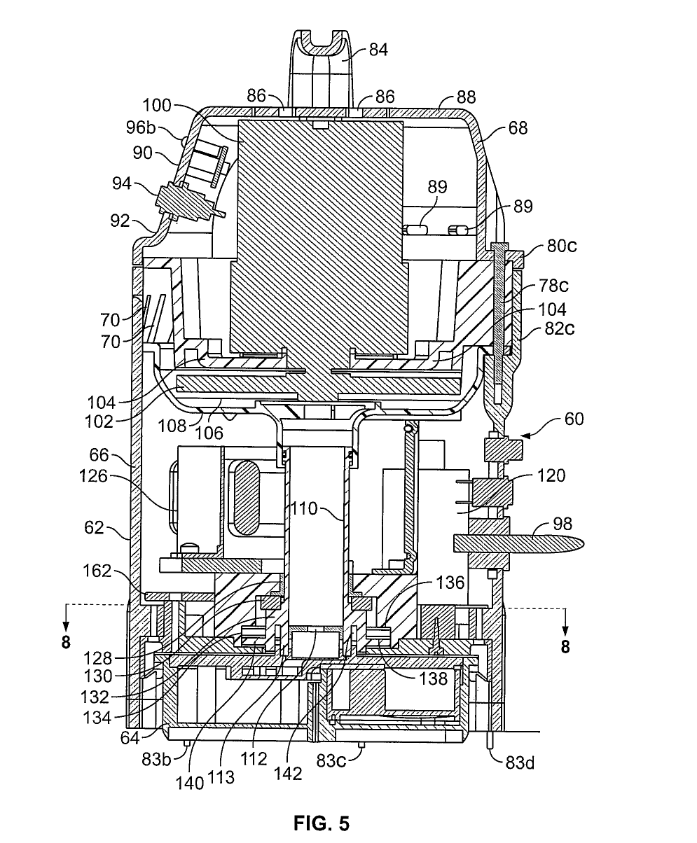

Referring first to FIGS. 1-3, a first embodiment of a cleaning device 60 according to the present invention comprises a main unit 62 and a removable cleaning receptacle 64 (FIGS. 2 and 3). The main unit 62 is generally cylindrical in shape and includes a chassis housing portion 66 and a head portion 68. The chassis housing portion 66 includes a series of exhaust slots 70, a movable release tab 72 and a further series of generally semi-cylindrical projections 74 disposed in spaced relation about a lower portion 76 of the body portion 66. Referring also to FIGS. 4 and 5, the head portion 68 is secured to the chassis housing portion 66 by a plurality of fasteners 78a-78c that extend through aligned bores in bosses 80a-80c, respectively, carried by the head portion 68 and anchor projections 82a-82c, respectively, carried by the chassis housing portion 66. A plurality of spring-loaded projections 83a-83f extend downwardly from every other of the projections 74 and function in a manner to hold the cleaning device 60 stationary during use, as described in greater detail hereinafter. The projections 83a-83f may be in the form of pins, bumps, nubs, hook and loop fasteners, or any other projection that can interact with fibers of a surface to engage the surface to stabilize the cleaning device 60.

The head portion 68 comprises a handle 84 secured by fasteners 85 (only one of which is visible in FIG. 1) to the balance of the head portion 68, a first series of cooling slots 86 extending through a top surface 88 of the head portion 68, a second series of cooling slots 89, and a control panel 90 forming a front face 92 of the head portion 68. In the illustrated embodiment, the control panel 90 includes a pushbutton switch 94 and a plurality of status indicators in the form of LED's 96a-96d. If desired, the pushbutton switch 94 and/or the LED's 96 may be replaced by other control(s) and/or indicator(s) (e.g., a rocker switch, a slide switch, a touch sensitive switch, or other switch, one or more incandescent lamps, an LED or TFT display, a vacuum fluorescent display, etc.) that allow a user to control the cleaning device 60 and/or monitor the progress thereof during a cleaning cycle. Electrical power for the various components of the cleaning device 60 may be provided via an electrical cord 98, which may be plugged into a standard household outlet (not shown).

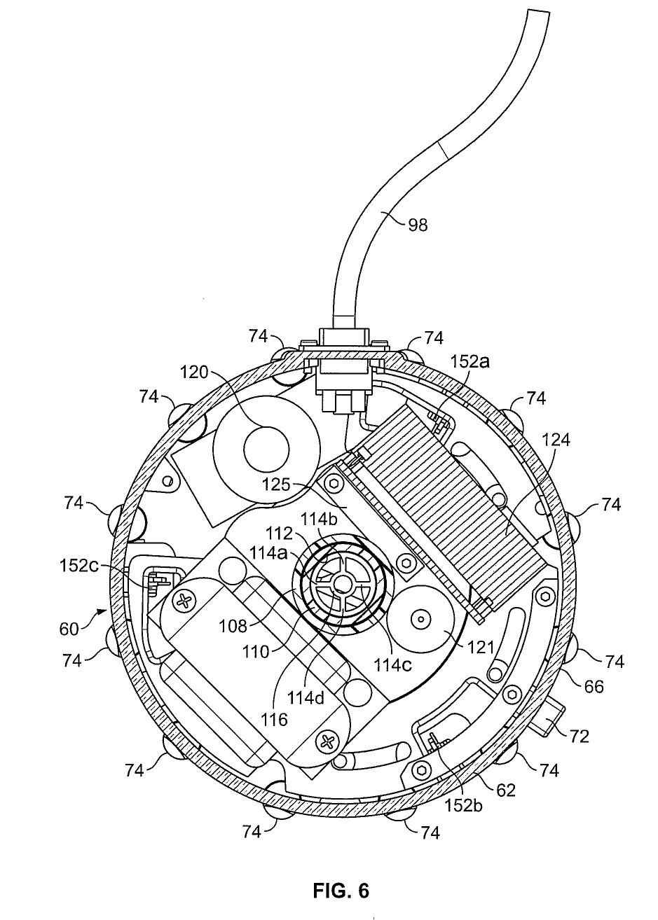

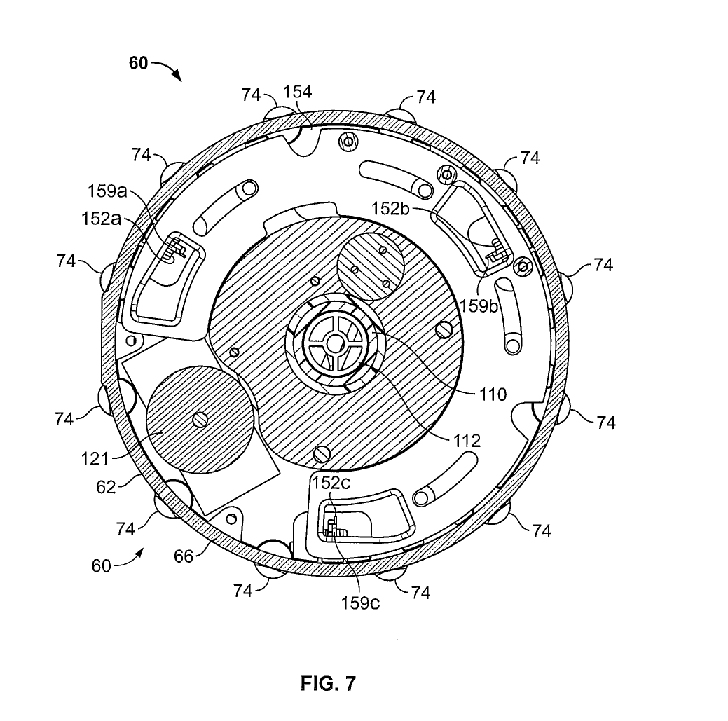

Referring next to FIGS. 4-9, the cleaning device 60 includes a first motor 100 that drives an impeller 102. The motor 100 is disposed within the head portion 68 and is supported therein by a support member 104 that is captured between the bosses 80 and the anchor projections 82. The impeller 102 is disposed within an impeller chamber 106 in part defined by walls 108. A rotatable cylindrical tube 110 is disposed in a lower portion of the walls 108 and a cup-shaped member 112 is carried in a lower or distal end 113 of the tube 110. The cup-shaped member 112 has cross members 114a-114d and a circular member 116 (the members 114a-114d and 116 are identified only in FIG. 6) supported by the cross members 114a-114d to form a structure that support a filter that prevents dust, fibers, and vaporized liquid from reaching the impeller 102 that might interfere with rotation thereof.

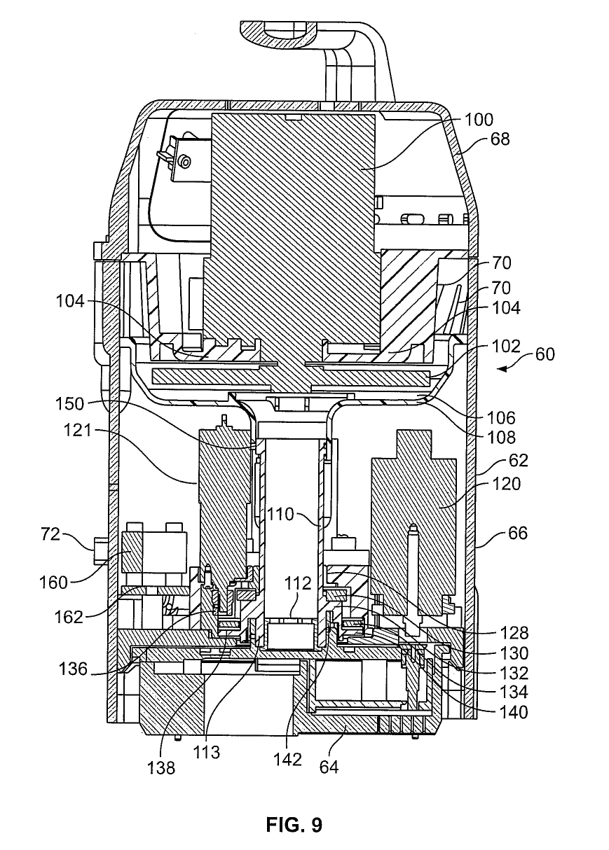

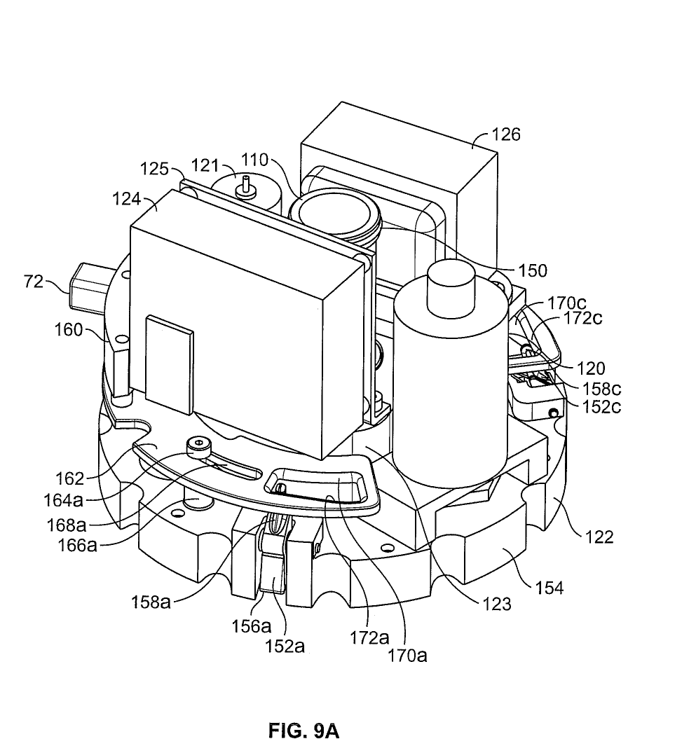

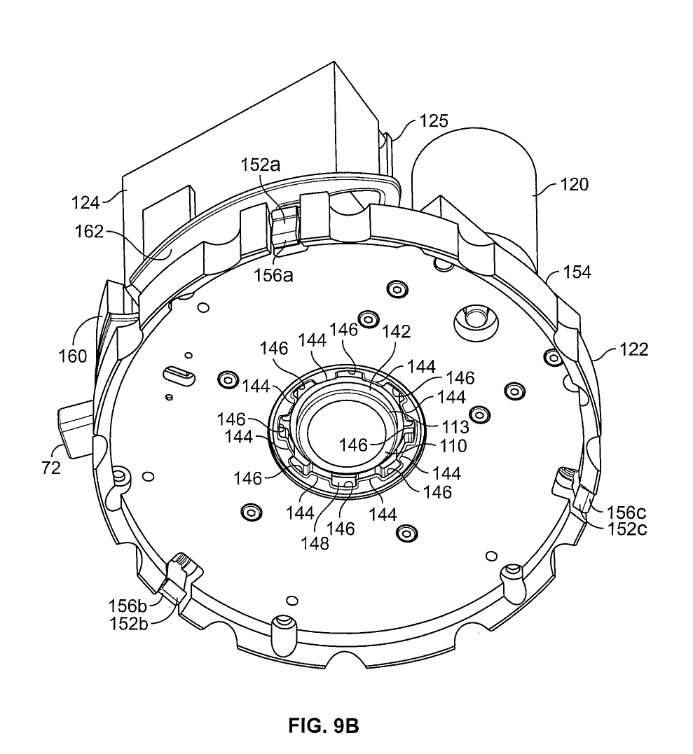

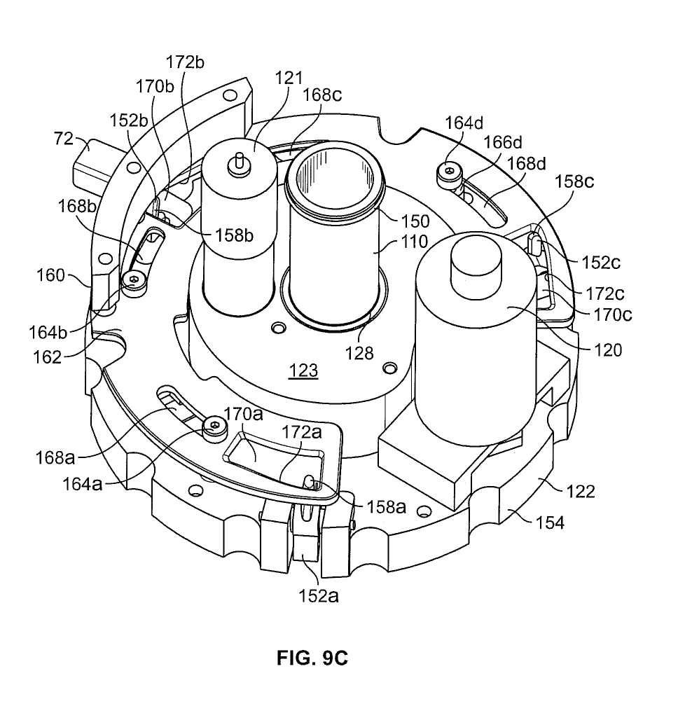

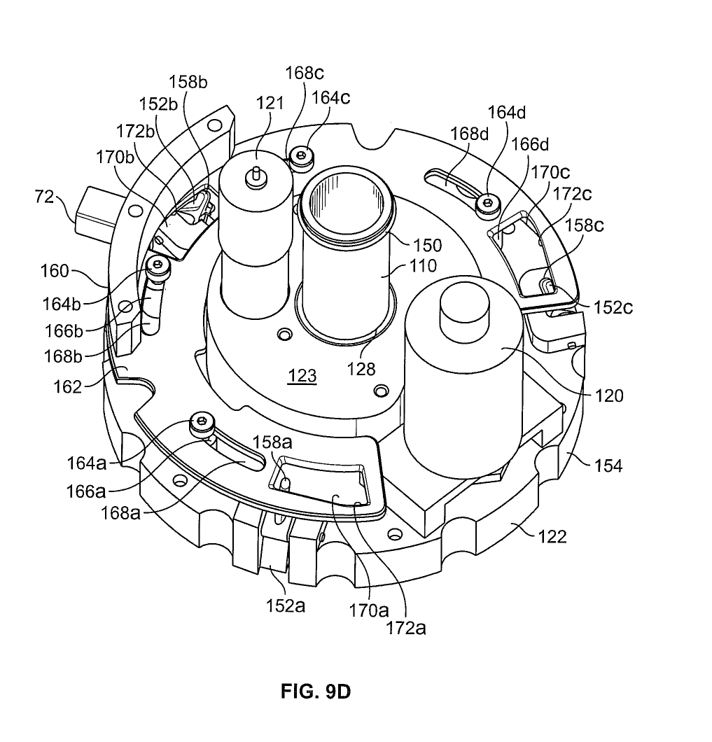

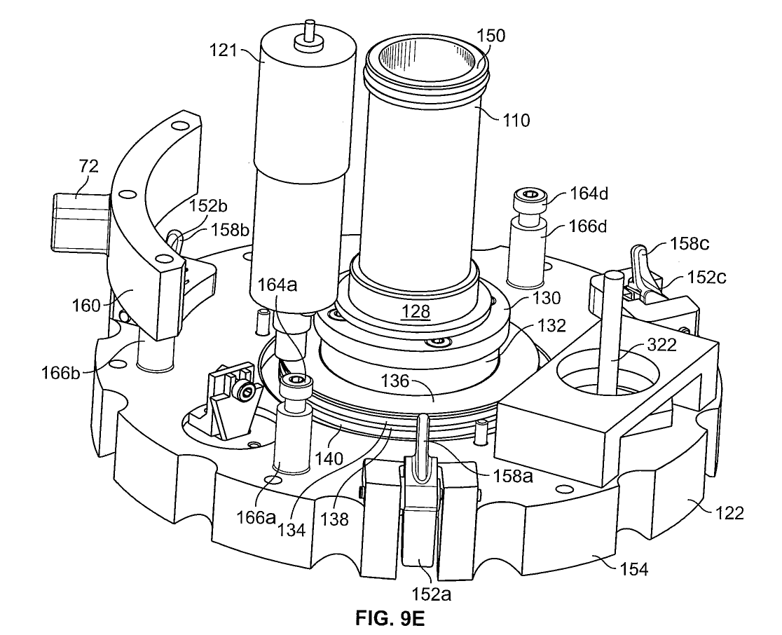

Referring also to FIGS. 9A and 9B, a solenoid 120 and a second motor 121 are carried on a main base plate 122 and an auxiliary base plate 123, respectively, secured to the main base plate 122. Circuitry 124 is mounted by a bracket 125 to the auxiliary base plate 123 as is a transformer 126. The circuitry 124 and the transformer 126 operate the motors 100 and 121 as well as the solenoid 120 in the fashion described in greater detail hereinafter. (The circuitry 124, the bracket 125 and the solenoid 126 are omitted in FIGS. 9C and 9D for the sake of clarity.) Referring also to FIGS. 4, 5, 9, and 9E (in which the auxiliary base pate 123 and the solenoid stator, among other structures, are further omitted as compared to FIGS. 9C and 9D), the tube 110 is supported for rotational movement by a flanged sleeve 128, a rotatable first bearing plate 130 fastened to a shouldered portion 132 of the tube 110, and a combination of a second bearing plate 134 and first and second washers 136, 138 disposed on opposite axial sides of the second bearing plate 134. A gear on a bottom end of the second motor 121 engages a surface of the shouldered portion 132 to drive the rotatable bearing plate 130, and thus the tube 110. Specifically, the first bearing plate 130 is disposed between the auxiliary base plate 123 and the shouldered portion 132. The combination of the second bearing plate 134 and the washers 136, 138 is disposed between the auxiliary base plate 123 and a radially outwardly extending flange 140 of the tube 110 such that the first washer 136 is disposed between the auxiliary base plate 123 and the second bearing plate 134 and the second washer 138 is disposed between the second bearing plate 134 and the flange 140 of the tube 110. The flange 140, in turn, extends radially outwardly from a hollow skirt 142 (FIGS. 4 and 5) of the tube 110. As seen specifically in FIG. 9B, gear teeth defined by circumferential, radially-inwardly extending lands 144 and grooves 146 are disposed within the skirt 142. An elastomeric sealing ring 148 is further disposed within the skirt 142 (seen only in FIG. 9B) and an O-ring 150 (FIGS. 4, 5, 9, 9A, and 9C-9E) is disposed about an upper portion of the tube 110 to provide sealing against the walls 108.

Referring specifically to FIGS. 6-9, and 9A-9E, a series of three spring-loaded pivoting clamps 152a-152c are carried at equally spaced locations on a peripheral rim 154 of the main base plate 122. Each of the clamps 152a-152c includes a downwardly extending hooked end 156a-156c, respectively, and an upwardly extending post 158a-158c, respectively. With specific reference to FIGS. 9A and 9B-9E, the release tab is carried by an arcuate arm 160 secured to an arcuate bracket 162. The bracket 162 is mounted for arcuate slidable movement between first and second movement limits by four bolts 164a-164d that are threaded into bores in bosses 166a-166d, respectively, of the main base plate 122. The bolts 164a-164d are threaded through slots 168a-168d, respectively, sufficiently to restrain the bracket 162 against substantially all but arcuate movement thereof. The bracket 162 further includes openings 170a-170c defined at least in part by cam surfaces 172a-172c, respectively. The posts 158a-158c are biased by springs 159a-159c, respectively (FIGS. 6-8) into rotational engagement with the cam surfaces 172a-172c, respectively. When the bracket 162 is in the position shown in FIG. 9C, the hooked ends 156a-156c are biased to an innermost position and when the bracket 162 is slid to the position shown in FIG. 9D, the hooked ends 156a-156c are biased to an outermost position. This movement between the innermost and outermost positions is effected by the spring loading of the pivoting clamps 152, and, in particular, the riding of the posts 158a-158c against the cam surfaces 172a-172c, respectively, in response to the forces exerted by the springs 159.

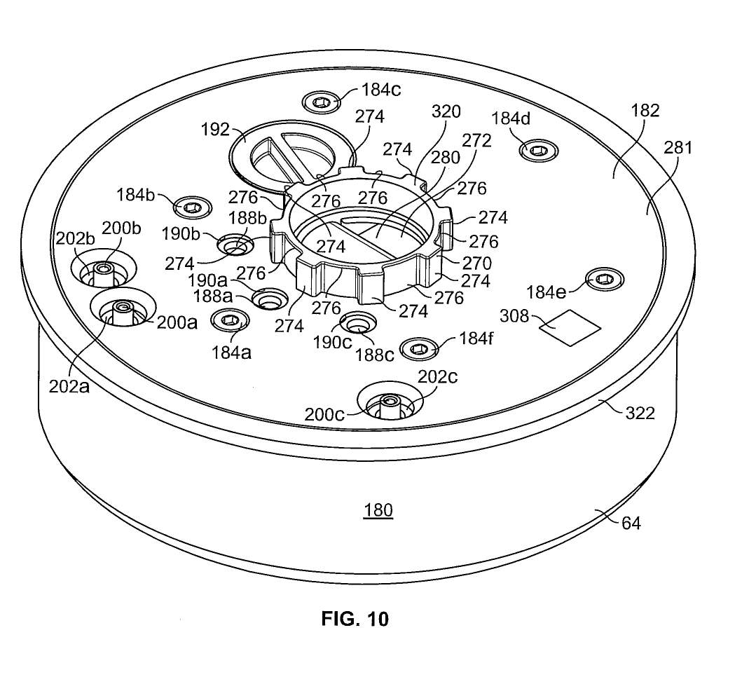

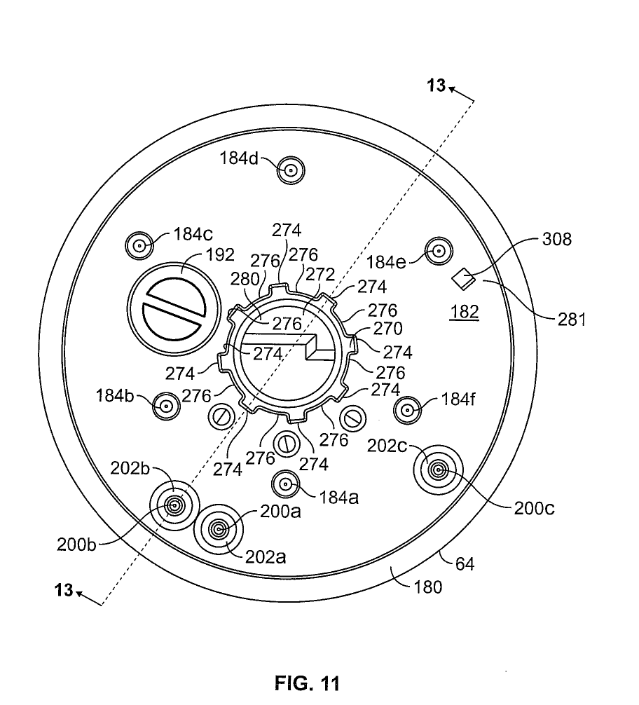

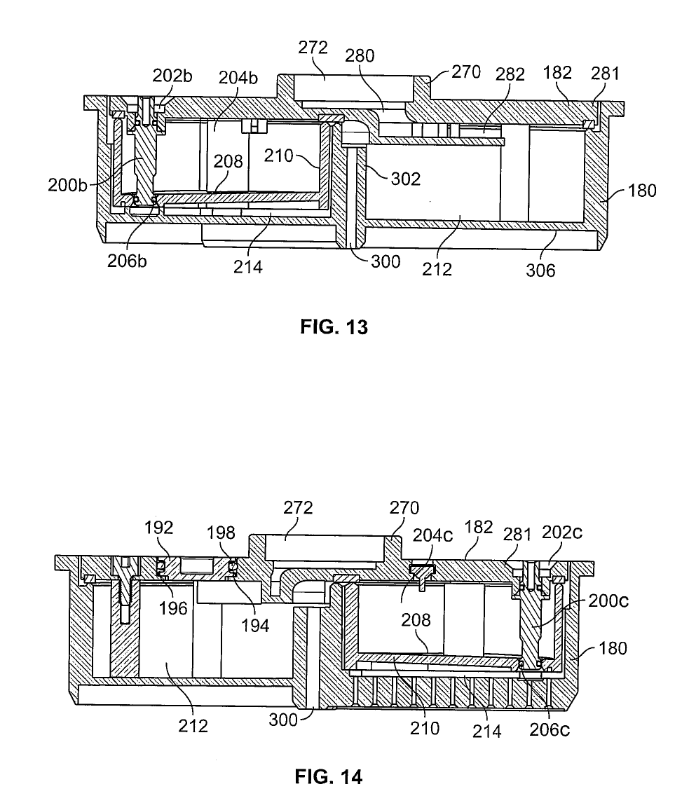

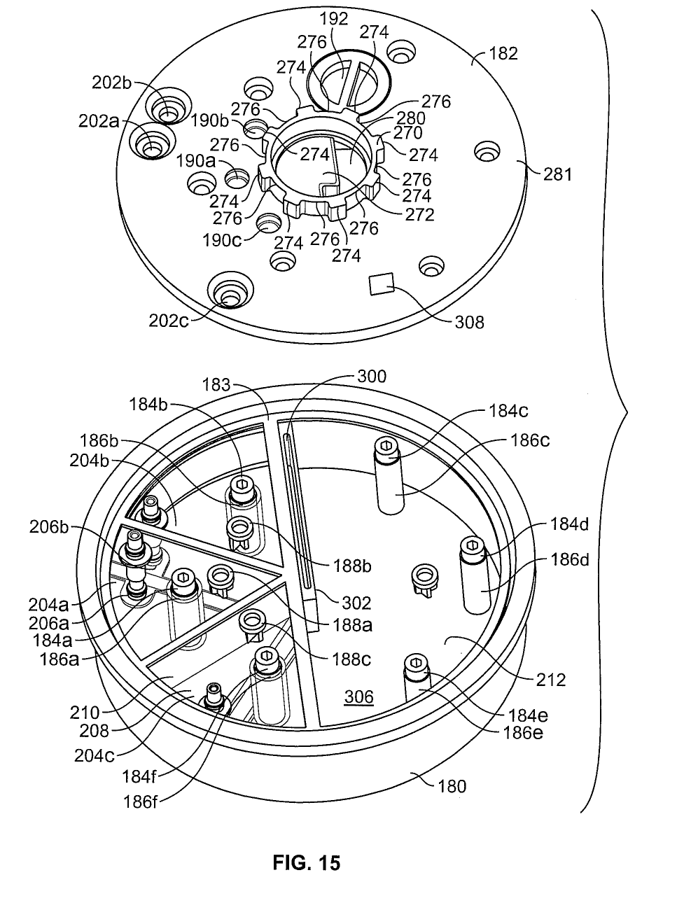

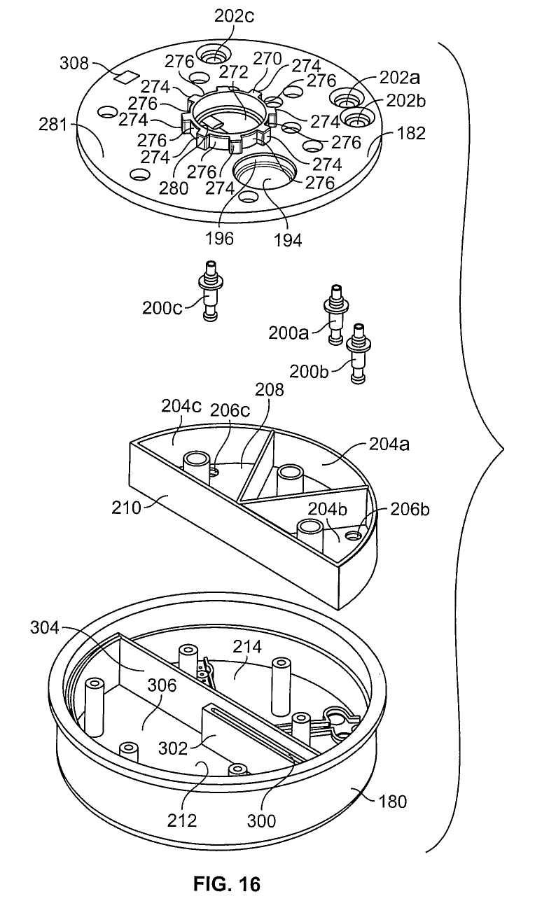

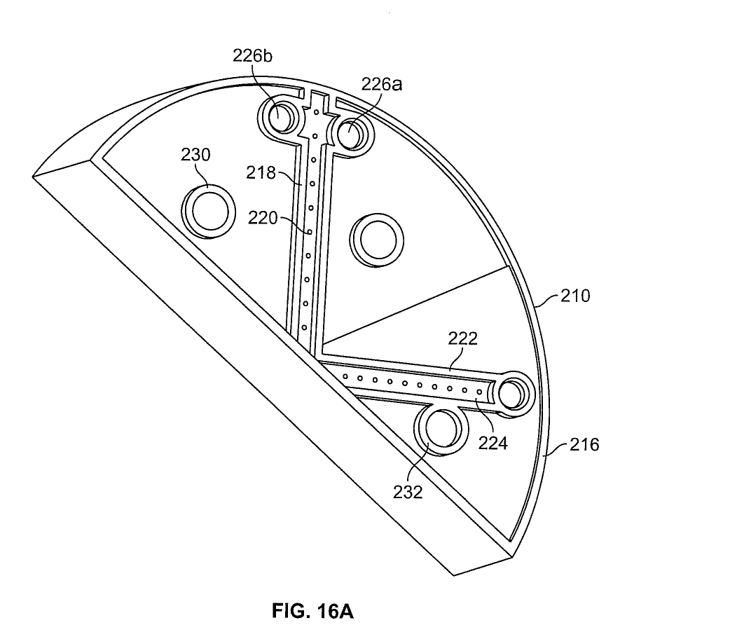

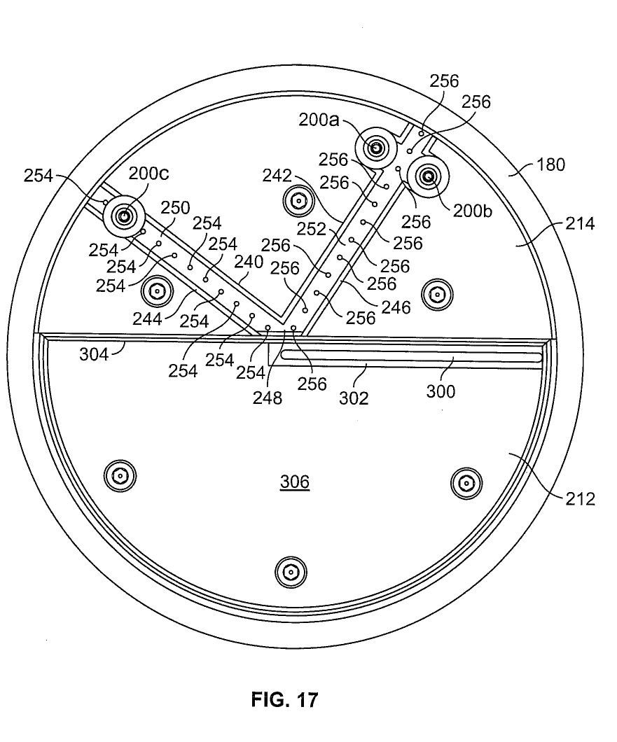

Referring next to FIGS. 10-12 and 15, the cleaning receptacle 64 is cylindrical in shape and includes a main body 180 and a disk-shaped cover 182 secured thereto with a gasket 183 (FIG. 15) therebetween. The cover 182 is secured to the main body 180 by a series of fasteners 184a-184f that extends through holes in the cover 182 and into aligned bores in stand-offs 186a-186f, respectively (FIG. 15). Removable filling caps 188a-188c are disposed in holes 190a-190c, respectively. Referring also to FIGS. 14 and 16, a further enlarged replaceable cap 192 is press-fitted into a bore 194 and is sealingly engaged with walls 196 defining the bore 194 by an O-ring 198. As seen in FIGS. 10, 11, and 13-16, three valves 200a, 200b, and 200c are disposed in tapered bores 202a, 202b, and 202c, respectively, extending through the cover 182. As seen in FIGS. 13-16, the valves 200a, 200b, and 200c extend into three compartments 204a, 204b, and 204c, respectively, and are seated and retained in bores 206a, 206b, and 206c, respectively, extending through a floor 208 of an insert 210. Referring also to FIG. 17, the main body 180 includes a fourth compartment 212 and a fifth compartment 214 within which the insert 210 is placed. The compartments 204a-204c, 212, and 214 preferably have one or more rigid walls that are non-expandable in that the one or more walls do not substantially increase in shape or size. As seen in FIG. 16A, the insert 210 includes a peripheral rim 216, first through fourth tapered ribs 218, 220, 222, and 224, respectively, a first set of annular collars 226a-226c through which the bores 206a-206c, respectively, extend, and a second set of annular collars 228, 230, and 232 through which the bores extending through the stand-offs 186a, 186b, and 186f, respectively, extend. The structures 216-226 rest on ribs 240, 242, 244, 246, and 248 to cause channels 250, 252 to be formed when the insert 210 is placed into the cleaning receptacle 64. The channel 250 includes a first plurality of openings 254 therethrough whereas the channel 252 includes a second plurality of openings 256 therethrough. The valve 200c is in fluid communication with the channel 250 while the valves 200a and 200b are in fluid communication with the channel 252. In the illustrated embodiment, the channel 250 is in fluid communication with the channel 252 in the area of the rib 248, although this need not necessarily be the case.

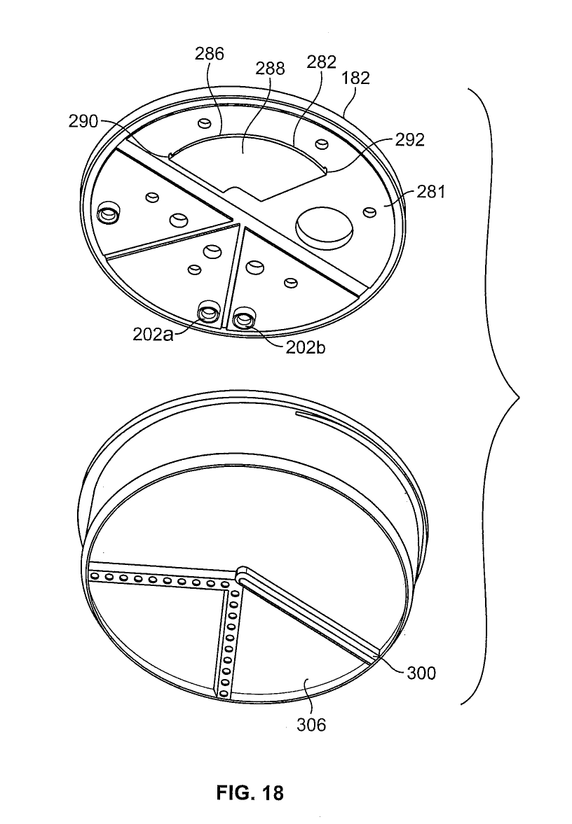

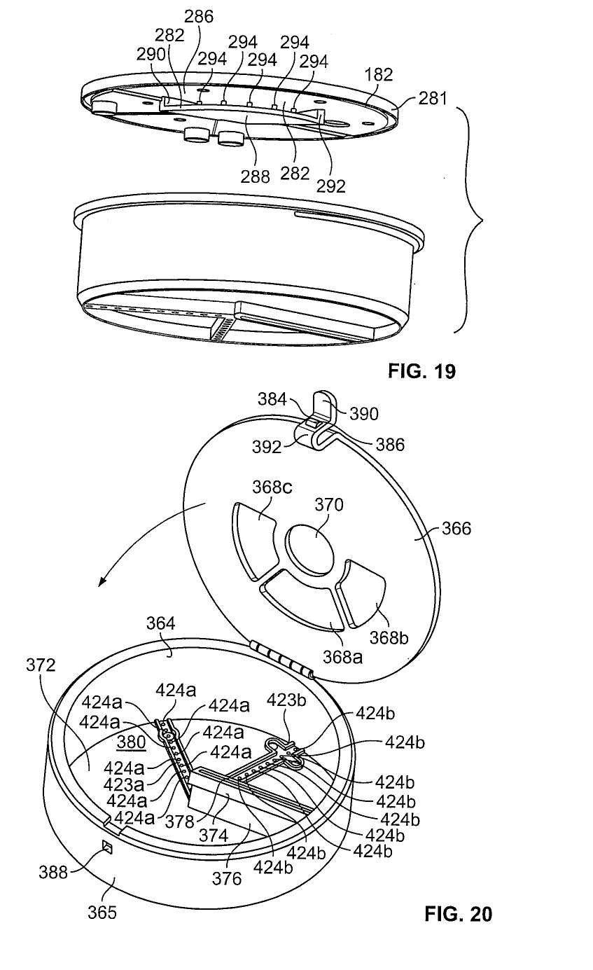

Referring again to FIGS. 10, 11 and 13-16, the cover 182 further includes a ring-shaped gear 270 disposed about a central aperture 272. The gear 270 includes alternating lands 274 and grooves 276 (identified in FIG. 10 only). The lands 274 and grooves 276 interfit with the lands and grooves 144, 146, respectively, (FIG. 9B) disposed on the lower end 113 of the cylindrical tube 110 when the cleaning receptacle 64 is placed on the main unit 62, as noted in greater detail hereinafter. A vacuum port 280 is disposed within the central aperture 272 and extends axially through a main body 281 of the cover 182 into fluid communication with a fan-shaped chute 282 (FIGS. 13, 18, and 19) located on a lower side 284 of the cover 182. As seen in FIGS. 18 and 19, an opening 286 of the chute 282 is directed generally opposite the bores 202a, 202b for the valves 200a, 200b, and the chute 282 is partially defined by a fan-shaped lower wall 288 and side walls 290, 292. A plurality of braces 294 are disposed between the lower wall 288 and the main body 281.

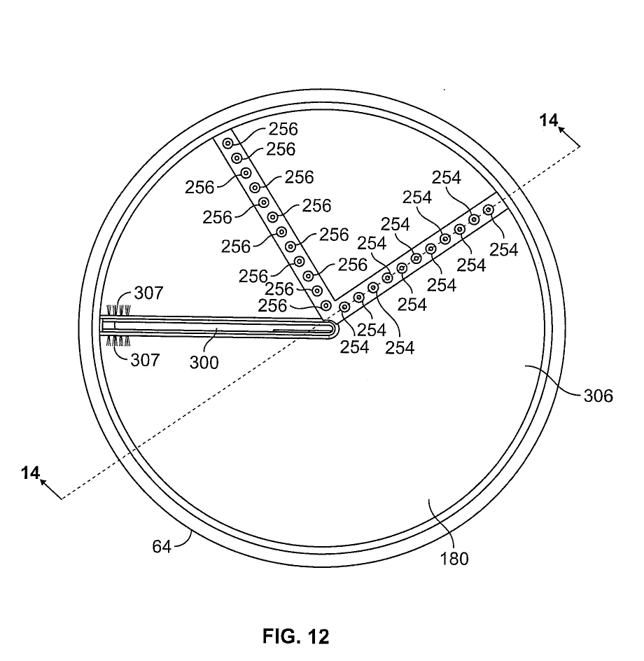

Referring next to FIGS. 12, 14-16, and 17, a slot 300 is defined by upstanding walls 302 in the main body 180 adjacent a divider wall 304 (FIGS. 16 and 17). The slot 300 extends fully through a bottom wall 306 of the main body 180. If desired, bristles 307 (FIG. 12) may be disposed on either side of the slot 300 and may be placed along the entire length of the slot 300 or may be placed at only one or more portion(s) along the length of the slot 300. (The bristles 307 are shown only at an outboard location of the slot 300 for simplicity.) Still further, bristles may be disposed at any location in any pattern (such as a straight line, a curved line, or the like) on the bottom wall 306, as desired.

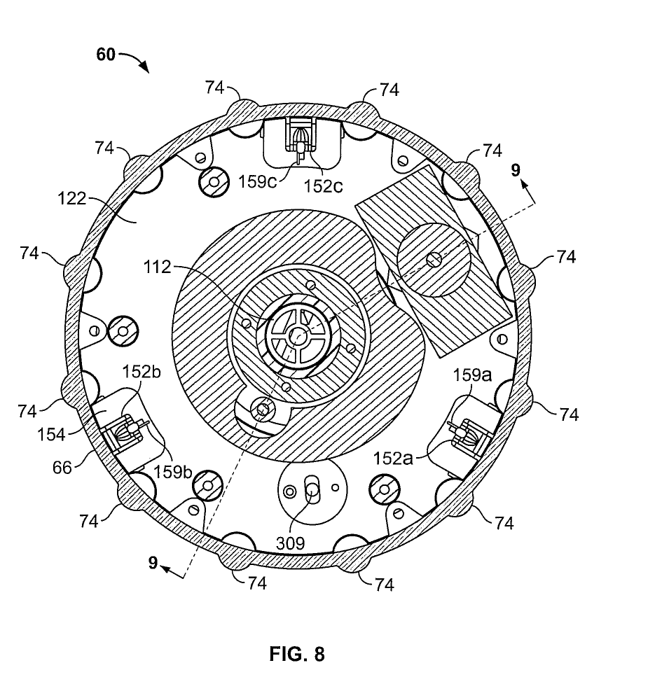

As seen in FIGS. 10, 11, 15, and 16, an indicator 308 may be disposed on the cleaning receptacle 64, preferably on a top surface of the cover 182. The indicator 308 is preferably in the form of a bar code, a data matrix code, or other optically read code. A reading device 309, such as an optical sensor or the like, as seen in FIG. 8, reads the indicator 308 and operates the cleaning device 60 in accordance with the indicator 308. Optionally, the indicator 308 may be in the form of a detent or projection that would indicate a physical position of the cleaning receptacle 64. The indicator 308 may allow for the manufacture of cleaning receptacles 64 for specific stains, such as for pet stains, wine stains, etc., wherein the indicator 308 includes information and/or directions regarding the cleaning receptacle 64. Specifically, the indicator 308 may contain information such as a number of compartments, the type of cleaner, if any, in each compartment, timing sequences for the cleaning receptacle 64, etc. The main unit 62 of the cleaning device 60 would also include a reading device for reading the indicator 308.

The cleaning receptacle is prepared for use by removing the filling caps 188a-188c from the cover 182 and filling the compartments 204a-204c with fluids. Preferably, one of the compartments 204, for example, the compartment 204b, is filled with a cleaning solution of any composition suitable for the surface to be cleaned. For example, where a spot on a carpet is to be cleaned, a commercially available carpet cleaning solution may be placed in the compartment 204b. If a portion of a linoleum or tile floor is to be cleaned, the compartment 204b may be filled with a suitable commercially available hard surface floor cleaner. The remaining compartments 204 are filled with one or more rinsing fluids, such as water or a rinsing composition of suitable type. Alternatively, one or more suitable cleaning solutions may be deposited in two of the compartments, such as the compartments 204a and 204b, and a rinsing fluid may be deposited in the remaining compartment 204c. More generally, any fluid(s) may be placed in any one or more of the compartments 204, provided that the fluids are suitable for the surface to be cleaned and the conditions under which cleaning is to occur. The caps 188a-188c may then be inserted into the respective holes 190a-190c. Optionally, the caps 188a-188c may be flexible valves such as duckbill valves that are normally sealed but can be opened with slight pressure, from an object (such as a tube or a syringe).

Once the compartments 204 are filled and the caps 188 placed in the holes 190, the cleaning receptacle 64 is mounted on the main unit 62. This is accomplished by moving the release tab 72 such that the bracket 162 is in the position shown in FIGS. 9A and 9D. This movement, in turn, causes the hooked ends 156a-156c of the clamps 152a-152c to be moved to the outermost position. The cleaning receptacle 64 is then placed onto the distal end 113 of the tube 110 such that the lands 274 and grooves 276 of the cover 182 interfit with the grooves 146 and lands 144 of the tube 110 and such that an upper surface 320 (see FIG. 10) of the ring-shaped gear 270 is disposed in sealing contact with the sealing ring 148 (FIG. 9B). The release tab 72 is then moved to an opposing position such that the bracket 162 is moved to the position shown in FIG. 9C. The hooked ends 156a-156c of the clamps 152a-152c are thereby moved to the innermost position, capturing a peripheral flange 322 (FIG. 10) while at the same time permitting rotation of the cleaning receptacle 64.

Once the cleaning receptacle 64 is mounted on the main unit 62, the cleaning device 60 is ready to clean a spot on a floor covering or other surface. The following steps are intended to be illustrative only, and the steps need not be undertaken in the sequence described, it being understood that the steps may be undertaken in a different sequence. Also, some steps may be omitted and/or added, and/or some steps may be substituted for other steps and the resulting method would still be considered to be within the scope of the present invention. A cleaning sequence begins by the user placing the device 60 directly on the spot to be cleaned. The user plugs the device 60 into a standard electrical outlet and thereafter depresses the pushbutton switch 94. The device 60 then undertakes a series of modes of operation as indicated by the LED's 96a-96d. If desired, a “prevacuuming” step may optionally be initially undertaken, wherein the cleaning receptacle 64 is rotated by the second motor 121 and the first motor 100 is energized to cause the slot 300 to be swept about a circular path atop the spot to be cleaned as a vacuum is drawn therethrough so that loose particles and soil are removed. Optionally, any other path may be utilized, such as a spiral path, an orbital path, or any other geometrically defined path. Following the optional “prevacuuming” step, the second motor 121 is operated to position the cleaning receptacle 64 relative to the main unit 62 such that a plunger 322 (FIG. 9E) of the solenoid 120 is positioned directly above the valve 200b, whereupon the motor 121 is stopped. The solenoid 120 is then actuated to cause the plunger 310 to move in a downward direction, thereby opening the valve 200b and causing the fluid stored in the compartment 204b to flow by means of gravity into the channel 252 (and, optionally, the channel 250 if the channels 250, 252 are in fluid communication with one another). Although a solenoid 120 and solenoid-operated sliding valves 200a-c are depicted, any actuating mechanism known in the art may be utilized to open the valves 200a-c and/or release fluids from the receptacle 64. Upon expiration of a first time period sufficient to ensure that the entire contents of the compartment 204b have flowed into the channel 252 (and, optionally, the channel 250), the solenoid 120 is deactuated to retract the plunger 322. Optionally, the valve 200b may also be closed. The fluid thus introduced into the channel 252 (and, optionally, the channel 250) flows through the openings 256 (as well as the openings 254 if fluid communication is present between the channels 252 and 250) and out of the cleaning receptacle 64. In this regard, it should be noted that the first time period is preferably not so long as to promote pooling or other undesirable local concentration of the fluid originally stored in the compartment 204b. Upon expiration of the first time period the motor 121 is actuated for a second time period to cause the cleaning receptacle to spin and thereby distribute and agitate the dispensed fluid into the spot to be cleaned. Optionally, the motor 121 may be actuated before the first time period has expired to prevent pooling or undesirable local concentration of the fluid. The duration of the second time period is preferably sufficient to ensure adequate distribution and agitation of the dispensed fluid, but is not so long as to promote wear of the surface to be cleaned.

Upon expiration of the second time period, the motor 121 may be optionally deactuated for a third time period. This dwell period may be interposed to permit the dispensed fluid to interact with the stain and/or soil so that cleaning effectiveness is increased. Once the dwell period has expired (if employed), the motors 100 and 121 are actuated for a fourth time period, thereby causing the cleaning receptacle 64 to be rotated and a vacuum to be developed at the slot 300. These actions, in turn, cause the dispensed fluid and the materials entrapped therein to be sucked into the fourth compartment 212. In this regard, because the fan-shaped chute 282 is directed generally opposite the bores 202a, 202b and the valves 200a, 200b, the chute 282 is also directed away from the slot 300, and hence, any liquid picked up during this step is directed through the slot 300 and either flows directly over the walls 302 defining the slot 300 into the compartment 212 and/or impinges on surfaces defining the compartment 212, such as surfaces of the lower side 284 of the cover 182, before settling in the compartment 212. Preferably, no liquid and/or debris entrained in liquid travels into the tube 110 at any time during pick up of liquid and/or debris (either during this step or any subsequent pick up step) because of the tortuous path for air movement defined by the fan-shaped lower wall 288 and side walls 290, 292.

Upon expiration of the fourth time period, the motor 100 is deactuated and the motor 121 is actuated to align the plunger 322 (FIG. 9E) of the solenoid 120 directly above the valve 200a, whereupon the motor 121 is stopped. The solenoid 120 is then actuated to depress and thereby open the valve 200a so that the contents of the compartment 204a flow by means of gravity into the channel 252 (and, optionally, the channel 250 if the channels 250, 252 are in fluid communication with one another). Upon expiration of a fifth time period sufficient to ensure that the entire contents of the compartment 204a have flowed into the channel 252 (and, optionally, the channel 250), the solenoid 120 is deactuated to retract the plunger 322. Optionally, the valve 200a may also be closed. The fluid thus introduced into the channel 252 (and, optionally, the channel 250) flows through the openings 256 (as well as the openings 254 if the channels 252 and 250 are in fluid communication with one another) and out of the cleaning receptacle 64. In this regard, it should be noted that the fifth time period (like the first time period) is preferably not so long as to promote pooling or other undesirable local concentration of the fluid originally stored in the compartment 204a. Upon expiration of the fifth time period the motor 121 is actuated for a sixth time period to cause the cleaning receptacle 64 to spin and thereby distribute and agitate the dispensed fluid into the spot to be cleaned. Again, the duration of the sixth time period is preferably sufficient to ensure adequate distribution and agitation of the dispensed fluid, but is not so long as to promote wear of the surface to be cleaned.

Upon expiration of the sixth time period, the motor 121 may be optionally deactuated for a seventh time period. As before, this dwell period may be interposed to permit the dispensed fluid to interact with the stain, soil, and/or prior dispensed fluid so that cleaning effectiveness is increased. Once the seventh time period has expired (if employed), the motors 100 and 121 are actuated for a eighth time period, thereby causing the cleaning receptacle 64 to be rotated and a vacuum to be developed again at the slot 300. The dispensed fluid and the materials entrapped therein are again sucked into the fourth compartment 212.

Once the eighth time period has expired, the motor 100 is again deactuated and the motor 121 is actuated to align the plunger 322 (FIG. 9E) of the solenoid 120 directly above the valve 200c, whereupon the motor 121 is stopped. The solenoid 120 is then actuated to depress and thereby open the valve 200c so that the contents of the compartment 204c flow by means of gravity into the channel 250 (and, optionally, the channel 252 if the channels 250, 252 are in fluid communication with one another). Upon expiration of a ninth time period sufficient to ensure that the entire contents of the compartment 204c have flowed into the channel 250 (and, optionally, the channel 252), the solenoid 120 is deactuated to retract the plunger 322. Optionally, the valve 200c may also be closed. The fluid thus introduced into the channel 250 (and, optionally, the channel 252) flows through the openings 254 (as well as the openings 256 if the channels 252 and 250 are in fluid communication with one another) and out of the cleaning receptacle 64. As was the case for the first and fifth time periods, the ninth time period is preferably not so long as to promote pooling or other undesirable local concentration of the fluid originally stored in the compartment 204c. Upon expiration of the ninth time period the motor 121 is actuated for a tenth time period to cause the cleaning receptacle 64 to spin and thereby distribute and agitate the dispensed fluid into the spot to be cleaned. As before, the duration of the tenth time period is preferably sufficient to ensure adequate distribution and agitation of the dispensed fluid, but is not so long as to promote wear of the surface to be cleaned.

Once the tenth time period has expired, the motor 121 may be optionally deactuated for an eleventh time period. As before, this dwell period may be interposed to permit the dispensed fluid to interact with the stain, soil, and/or prior dispensed fluids so that cleaning effectiveness is increased. Once the eleventh time period has expired (if employed), the motors 100 and 121 are actuated for a twelfth time period, thereby causing the cleaning receptacle 64 to be rotated and a vacuum to be developed again at the slot 300. The dispensed fluid and the materials entrapped therein are once more sucked into the fourth compartment 212.

In the preferred embodiment the first through twelfth periods of time have the following durations and LED statuses, although such durations and statuses may be varied as appropriate or desired:

| | Duration | | |
|---|---|---|---|
| Time Period | (seconds) | Step | LED status |
| Plug in/turn on | | | 96a and 96b on |
| Push start | | | |
| button | | | |
| Initial prevac | 30 | Prevacuum | 96a and 96c on, 96b off |
| First | 5 | Find valve | 96a and 96c on, 96b off |
| Second | 30 | Dispense/mix | 96a and 96c on, 96b off |
| Third | 300 | Soak/dwell | 96a and 96c on, 96b off |
| Fourth | 30 | Extract | 96a and 96c on, 96b off |
| Fifth | 5 | Find valve | 96a and 96c on, 96b off |
| Sixth | 30 | Dispense/mix | 96a and 96c on, 96b off |
| Seventh | 10 | Soak/dwell | 96a and 96c on, 96b off |
| Eighth | 30 | Extract | 96a and 96c on, 96b off |
| Ninth | 5 | Find valve | 96a and 96c on, 96b off |
| Tenth | 30 | Dispense/mix | 96a and 96c on, 96b off |
| Eleventh | 10 | Soak/dwell | 96a and 96c on, 96b off |
| Twelfth | 30 | Extract | 96a and 96c on, 96b off |
| END | | | 96d on, 96a off, 96c off |

While in use, the LED's 96a-96d are selectively energized to indicate the status of operation of the cleaning device 60, as detailed in the above chart. The LED 96a is an indicator that energy is being supplied to the device 60 and the LED 96b is an indication that the device 60 is ready for cleaning. When the LED's 96a, 96b are both on, the device 60 may be started. Once the push button switch 94 is depressed, the LED 96c is illuminated. The LED 96d indicates that a cleaning cycle is complete. Once the cleaning steps are complete, the release tab 72 is moved to the position shown in FIGS. 9A and 9D. This movement, in turn, causes the hooked ends 156a-156c of the clamps 152a-152c to be moved to the outermost position, thereby releasing the cleaning receptacle 64. The main unit 62 may then be lifted off of the cleaning receptacle 64 and the cleaning receptacle 64 may then be carried to a sink or other place of disposal, whereupon the enlarged replaceable cap 192 can be removed from the bore 194 to permit emptying of the fourth compartment 212. Alternatively, the entire cleaning device 60 may be carried to a place of disposal and tab 72 may be actuated to release the cleaning receptacle 64 thereby ejecting the cleaning receptacle 64 into the place of disposal. This scenario is advantageous because a user never has to contact a dirty and/or used cleaning receptacle 64. If desirable or necessary, the fourth compartment 212 may be also rinsed out at this time, as may any or all of the compartments 204a-204c by removing the filling caps 188a-188c to permit access thereto, following which the various parts may be set aside to dry. Once dry, the various parts may be reassembled together and the cleaning receptacle 64 may be replaced on the main unit 62.

The projections 83a-83f prevent relative movement of the main unit 62 relative to the surface to be cleaned during the above sequence of steps. Specifically, the projections 83 are spring-biased into contact with the surface to be cleaned. In the case when the surface comprises a carpet or rug 324 (FIG. 2), the projections 83 are urged downwardly into the pile or nap of the carpet or rug 324. If necessary or desirable, the projections 83 may have pointed tips or the projections 83 may be replaced by any other suitable structure that prevents relative movement of the main unit 62 and the surface to be cleaned.

In the preferred embodiment, the fluid in the compartment 204b is a low foaming detergent. One example of a commercially available low foaming detergent is Fantastik® Oxy, which is sold by S. C. Johnson & Son, Inc. of Racine, Wis.

Also, the fluid disposed in the compartments 204a and 204c comprises water or another rinsing agent. Still further, the various parts of the cleaning receptacle 64 (with the exception of the O-ring 198) are preferably made of plastic of any suitable type, although different material(s) may instead be used, such as metal in the form of aluminum and/or steel, or coated papers, or combinations of plastic or metal or paper. The main body 180 and the compartments 204a-204c of the cleaning receptacle 64 may be made of a transparent plastic material to allow a user to view extracted dirt and fluids.

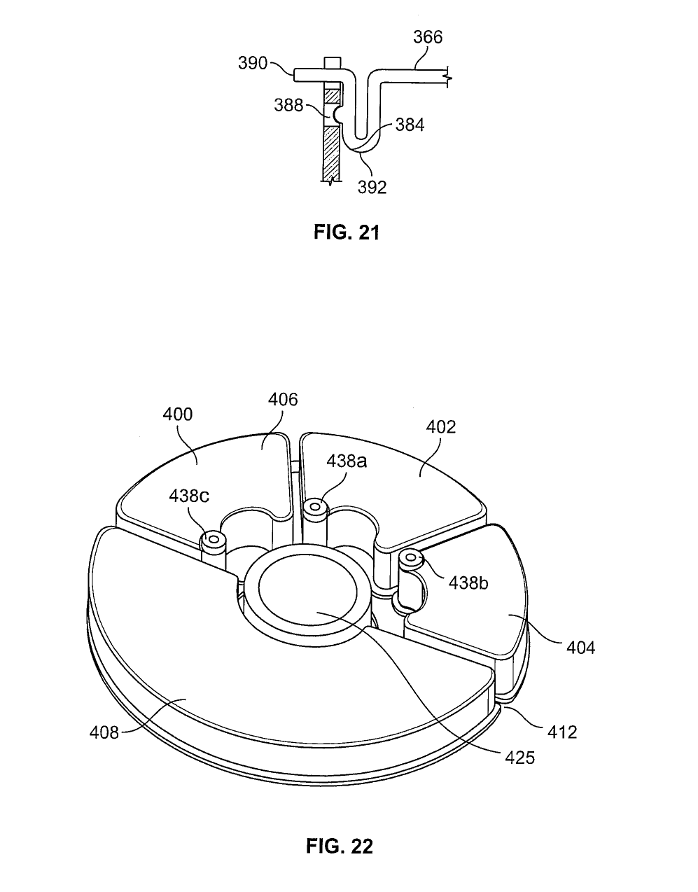

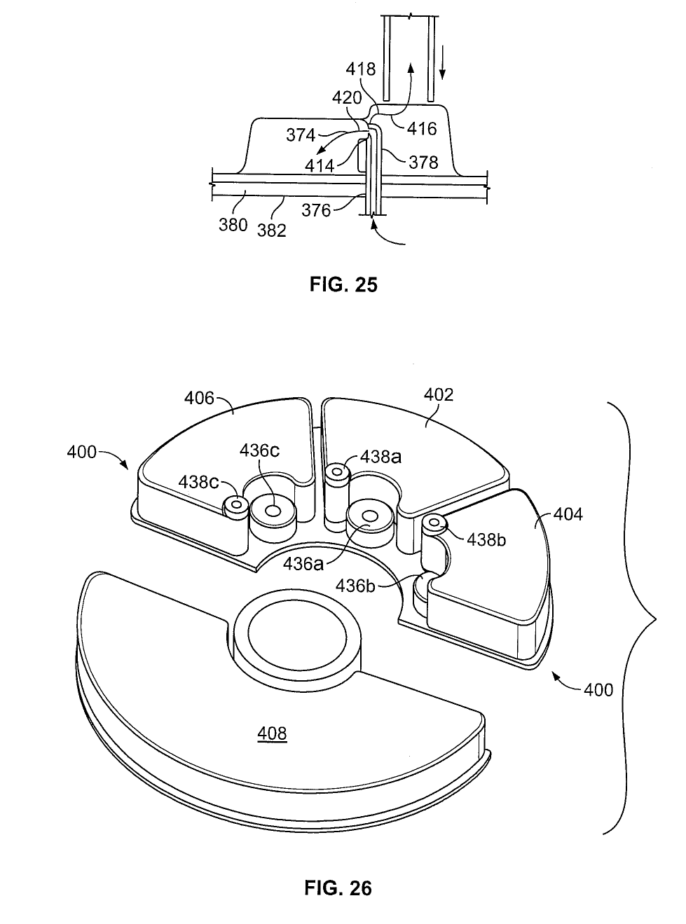

Referring next to FIGS. 20, 21, 23, and 24, a further cleaning receptacle 364 usable with the main unit 62 includes a main body 365 and a disk-shaped hinged cover 366 having a series of holes or apertures 368a-368c and 370 extending therethrough. The main body 365 is cylindrical in shape and defines a compartment 372 having a vacuum slot 374 therein defined in part by walls 376, 378 extending upwardly from a bottom wall 380 (FIG. 20). As in the previous embodiment and as illustrated in FIG. 25, the slot 374 extends through the bottom wall 380 and may be surrounded by bristles (not shown) secured to a lower surface 382. Further, as seen specifically in FIGS. 20 and 21, the cover 366 includes a flexible hook-shaped latch 384 having a bump-shaped protrusion 386 that resides in a hole 388 disposed in the main body 365 when the cover 366 is closed and latched. When it is desired to open the cover 366, a user presses inwardly on the a tab 390 of the latch 384, thereby causing the latch 384 to flex inwardly about a hinge portion 392, allowing the protrusion 386 to move out of interfering relationship with walls defining the hole 388. The user may then pull up on the tab 390 and swing the cover 366 open.

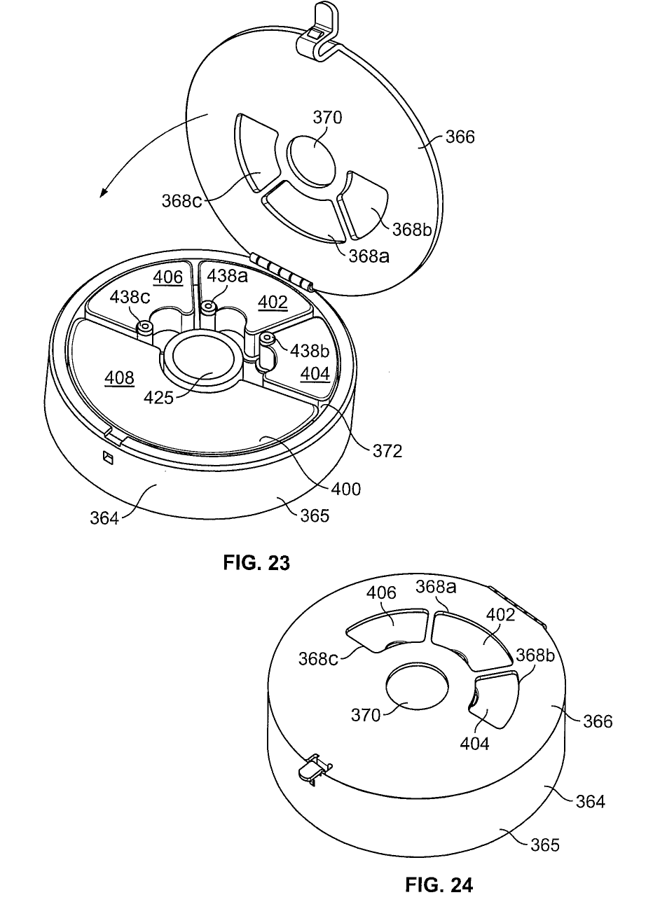

Referring to FIGS. 22 and 23, an insert 400 is designed to be received in the compartment 372. The insert 400 includes four non-expandable compartments 402, 404, 406, and 408, which, in the preferred embodiment, are joined together by webs of material. Preferably, the webs of material and the material forming the compartments are made of a thermoformed plastic material and/or a combination of a thermoformed plastic and aluminum foil covers and the insert 400 is light, flexible, and disposable after use, as described in greater detail hereinafter. Also preferably in the embodiment of FIGS. 21-25, all of the compartments 402, 404, 406, and 408 are unitary with one another and with the webs of material so that the insert 400 comprises a single unit. Still further, in the preferred embodiment, the compartments 402, 404, and 406 are prefilled with cleaning solution(s) and rinsing solution(s), the compartment 408 is left in an unfilled state, the compartments 402, 404, and 406 are sealed and the insert 400 is intended for one-time use. In this regard, the compartment 408 is provided with either an initially sealed or unsealed opening 410 (FIG. 25), which, after opening (if initially sealed) is intended for sealing engagement with the walls 376, 378. As seen in FIG. 22, there is a gap 412 between the compartments 402 and 480 that allows the insert 400 to be placed into the compartment 372 such that the walls 376, 378 extend upwardly between the compartments 402, 408 and such that turned portions 414, 416 of the walls 376, 378 extend into sealing contact with surfaces 418 defining an opening 420 in the compartment 408 (FIG. 25). The compartment 372 includes first and second channels 423a, 423b therethrough; each including a plurality of apertures 424a, 424b, respectively, therein. Fluids are dispensed out of the compartment 372 in a similar manner as that of FIGS. 10-12 and 15. The rotatable cylindrical tube 110 of the cleaning device main body 62 communicates with a rigid hollow opening 425 through aperture 370 to provide suction to the receptacle 64 for picking up dirt and fluids. The receptacle 364 is mounted and driven in a manner similar the manner in which the receptacle 64 of FIGS. 10-18 is mounted to and driven by the cleaning device 20.

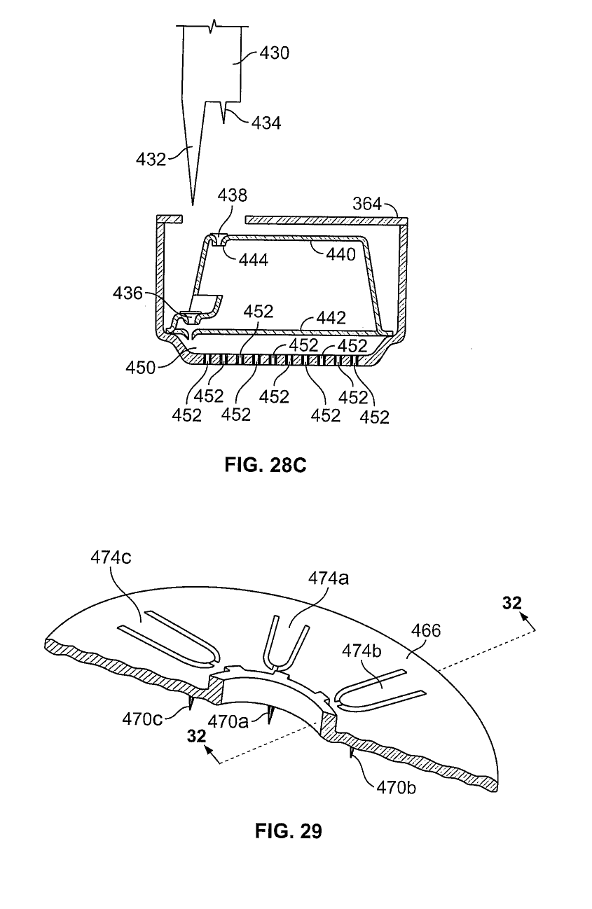

In operation, once the insert 400 is placed into the compartment 408, the cover 366 is swung closed and latched in the closed position by the latch 384. Either before or after mounting on the main unit 62, a piercing operation is undertaken to pierce the compartments 402, 404, and 406. For example, with specific reference to FIGS. 28A-28C, the receptacle 364 may be initially mounted on the main unit 62. As seen in FIGS. 28A-28C, the main unit 62 is provided with a movable piercing member 430 that can be moved up and down by a motor, another motive power source (such as the solenoid 120 of the previous embodiment), or by the user. The piercing member 430 includes first and second piercing elements 432, 434, respectively, that are movable into corresponding piercing bosses 436, 438, respectively, on one of the compartments 402, 404, or 406 to pierce a lower main drain hole through upper and lower walls 440,442 forming the compartments 402-406 and further to pierce an upper vent hole in an upper portion 444 of the upper wall 440 defining the corresponding compartment 402, 404, and 406. Each of the piercing bosses 436, 438 may comprise a weakened area that may or may not be surrounded partially or fully by a strengthened area. The weakened area could simply be an area of thinned material or an area that is partially scored, such as by a knife or a laser.

The main unit 62 may undertake the same series of steps as described above with respect to the previous embodiment, with the exception that the steps of opening each of the valves 200a-220c may be replaced by the steps of individually piercing the compartments 402, 404, and 406 at the same points in the cleaning process to release cleaning fluid(s) and rinsing fluid(s). That is, with reference also to FIG. 26 (which illustrates a further embodiment of a multi-part insert described in greater detail hereinafter), the cleaning receptacle 364 is rotated to and stopped at a first position to align the piercing elements 432, 434 with the piercing bosses 436b, 438b, respectively, of the compartment 404 whereupon the piercing member 430 is moved downwardly to cause the piercing elements 432, 434 to extend through the hole 368a, (FIG. 24) and thereby form the main drain hole and the upper vent hole in the piercing bosses 436b, 438b of the compartment 404 as noted above. Fluid in the compartment 404 flows out of same into a recess 450 (FIGS. 28A-28C) below the insert 400 and out a series of openings 452 that extend through the bottom wall 380. Once the piercing member 430 has been retracted (i.e., raised), the fluid originally stored in the compartment 404 has been discharged and agitated, and following an optional dwell step as in the previous embodiment, the motors 100, 121 are actuated to cause the main unit 62 to pick up the liquid and any entrapped debris and deposit same in the compartment 408. Thereafter, the cleaning receptacle 364 is rotated and stopped at a position aligning the compartment 402 with the piercing elements 432, 434. The piercing member 430 is then advanced (i.e., lowered) to cause the piercing elements 432, 434 to extend through the hole 368a and pierce and form the main drain hole and the upper vent hole in the piercing bosses 436a, 438a. The liquid stored in the compartment 402 flows into the recess 450 and out through the openings 452 onto the spot to be cleaned.

Once the piercing member 430 has been retracted, the liquid originally stored in the compartment 402 has been discharged and agitated, and following an optional dwell period, the motors 100, 121 are actuated to cause the main unit 62 to pick up the liquid and any entrapped debris and deposit same in the compartment 408. Thereafter, the cleaning receptacle 364 is again rotated and stopped at a position aligning the compartment 406 with the piercing elements 432, 434. The piercing member 430 is then advanced to cause the piercing elements 432, 434 to extend through the hole 368c and pierce and form the main drain hole and the upper vent hole in the piercing bosses 436c, 438c. The liquid stored in the compartment 406 flows into the recess 450 and out through the openings 452 onto the spot to be cleaned. The piercing member 430 is again retracted, and the agitation, optional dwell and motor energization steps are again undertaken to cause liquid and/or debris pick up as before.

When the cleaning cycle is complete, the release tab 72 is moved to the position shown in FIGS. 9A and 9D. This movement, in turn, causes the hooked ends 156a-156c of the clamps 152a-152c to be moved to the outermost position, thereby releasing the cleaning receptacle 64. The main unit 62 may then be lifted off of the cleaning receptacle 64 and the cleaning receptacle 64 may then be carried to a place of disposal, opened, and the insert 400 may be removed and discarded. The cleaning receptacle 364 may thereafter be reloaded with a fresh insert 400 as desired and the receptacle 364 may be replaced on the main unit 62.

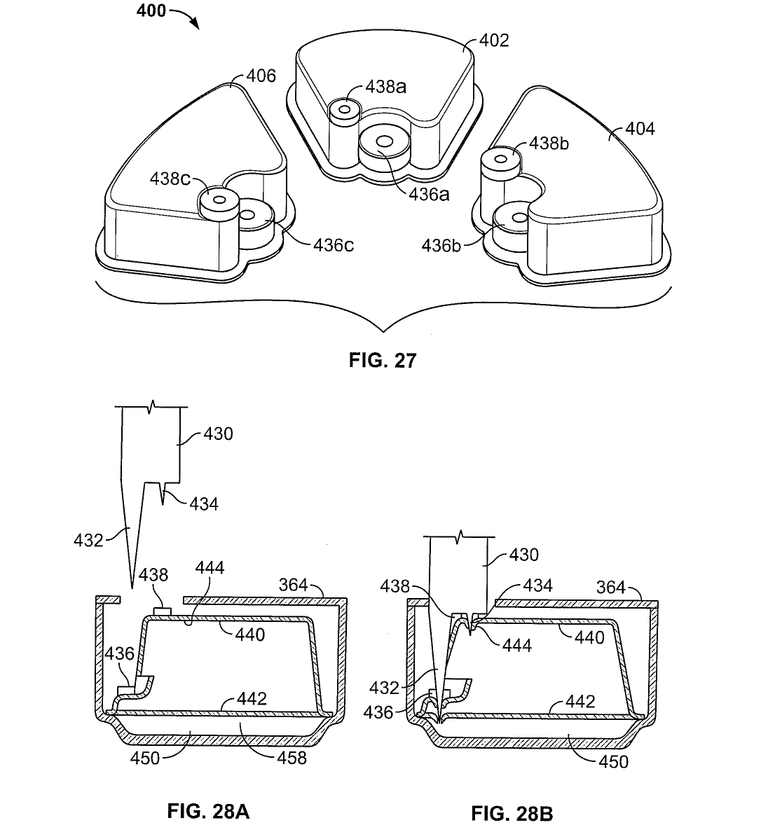

If desired, the insert 400 may comprise a multi-part (in non-unitary) series of components. For example, as seen in FIG. 26, the compartment 408 may be separate from the compartments 402-406. In a still further alternative illustrated in FIG. 27, the compartments 402-408 may all be separate from one another, or one or more compartments of a first set may be interconnected by webs and the remaining compartment(s) of a second set may be separate from the compartments of the first set. More generally, the compartments may be subdivided into multiple sets, where the compartments of each set may or may not be interconnected together by one or more webs. In any case, the compartment 408 may be intended for single use or multiple uses.

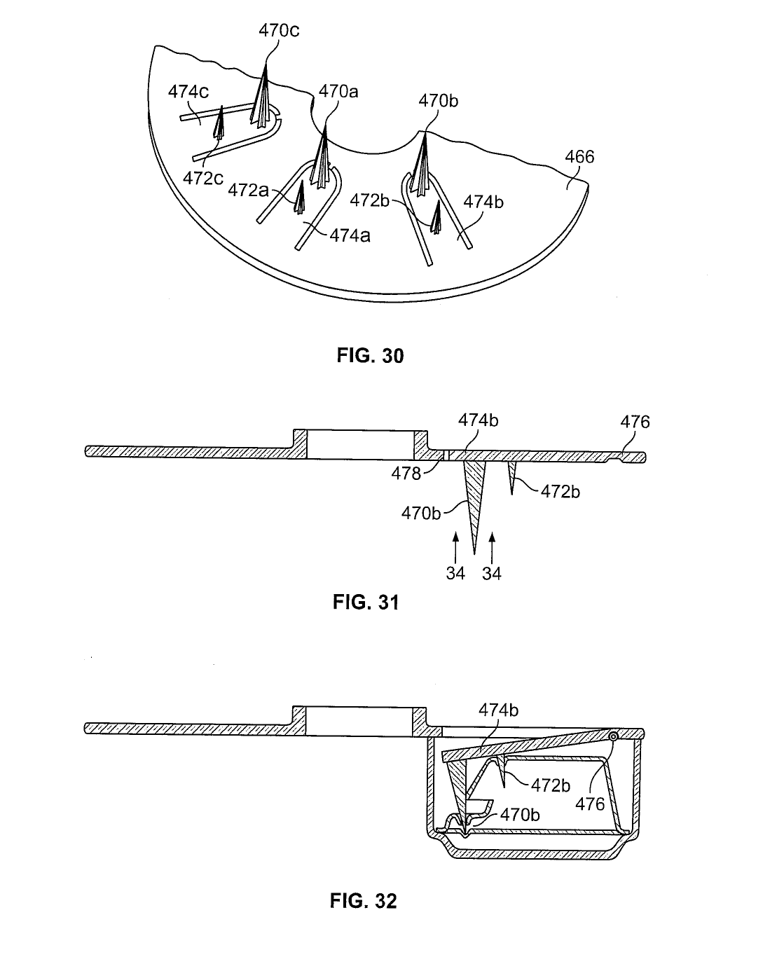

Also if desired, the piercing elements 432, 434 and the cover 366 may be replaced by a cover 466 having integral piercing elements 470a-470c and 472a-472c, respectively, as seen in FIGS. 29 and 30. The piercing elements 470, 472 are carried by flexing arms 474a-474c. The piercing elements 470a, 472a are aligned with the piercing bosses 436a, 438a, respectively, whereas the piercing elements 470b, 472b are aligned with the piercing bosses 436b, 438b, respectively, and the piercing elements 470c, 472c are aligned with the piercing bosses 436c, 438c, respectively, when the insert 400 of any of the previous FIGS. is inserted into the cleaning receptacle 364. The operation of the main unit 62 and cleaning receptacle is identical to that described above in connection with FIGS. 20-28 with the exception that the solenoid 120 (or other source of motive power) bears against and moves the flexing arms 474a-474c at the appropriate times in the cleaning process to open the compartments 402-406 in the fashion described above. With reference to FIGS. 31 and 32, each of the flexing arms 474a-474c may be coupled to the remainder of the cover 466 by thinned portions acting as hinges 476 (only the hinge 476 associated with the flexing arm 474 b is shown in the FIGS.). If necessary or desirable, each of the flexing arms 474 may initially be connected by a web in the form of a frangible section 478 that is broken when downward pressure is applied against the associated flexing arm 474, such as when the solenoid 120 is actuated to cause the piercing elements 470a-470c and 472a-472c to pierce the piercing bosses 436a-43c and 438a-438c, respectively.

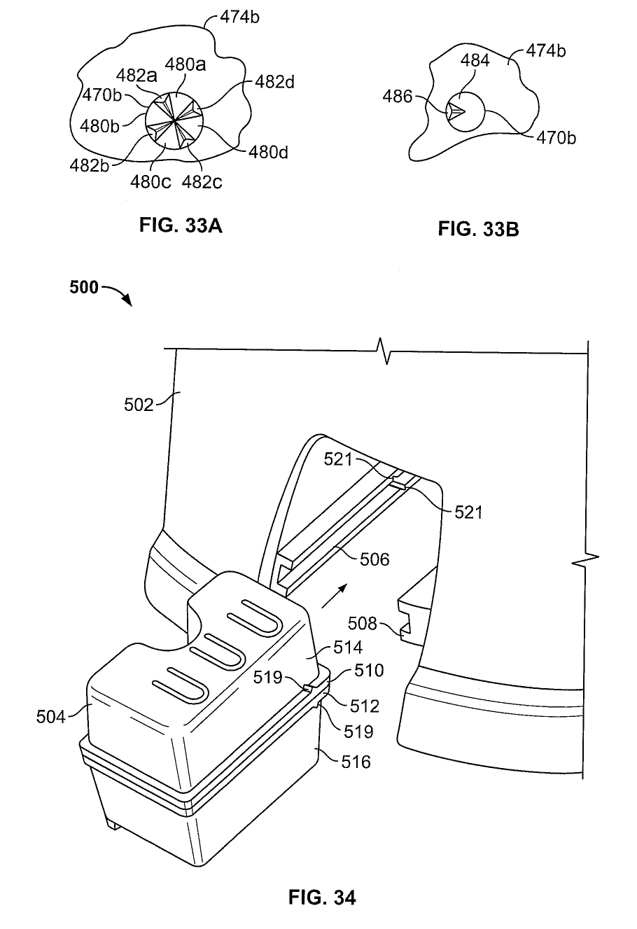

Referring to FIGS. 33A and 33B, each of the piercing elements 432a-432c, 434a-434c, 470a-470c, and/or 472a-472c may be tapered from top to bottom and may include one or more longitudinal channels that allow fluid to flow in or out of a compartment when same is pierced. For example, with specific reference to FIG. 33A, the piercing element 470b may have a cross-shaped cross-sectional configuration including four tapered main longitudinal members 480a-480d separated from one another by channels 482a-482d. An alternative is illustrated in FIG. 33B wherein the piercing element 470b has a tapered main conical shape 484 with a wedge-shaped portion 486 removed therefrom. It is not necessary that all of the piercing elements 432, 434, 470, and 472 have the same cross-sectional configurations; in fact, fewer than all of the piercing elements may have one cross-sectional configuration and the remainder may have a different cross-sectional configuration, all of the piercing elements may have different cross-sectional configurations, etc.

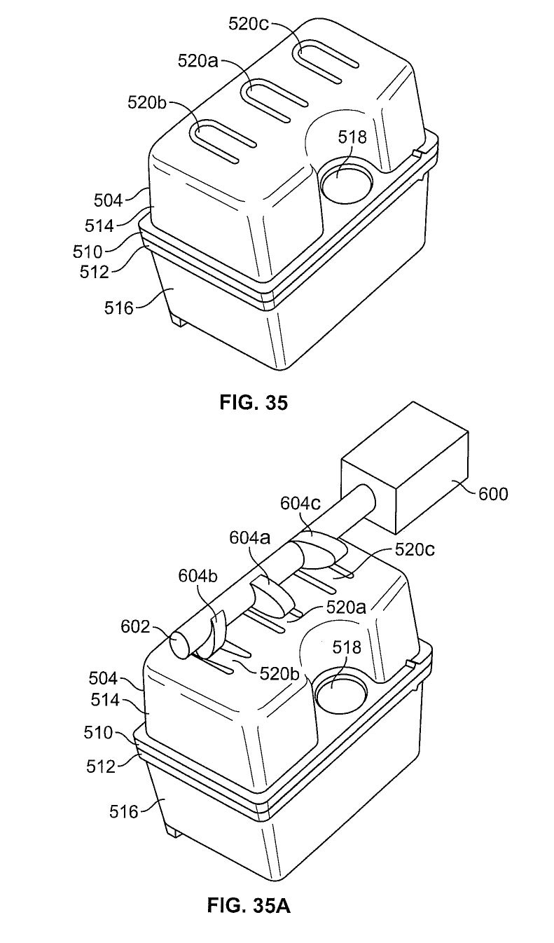

FIGS. 34-39 illustrate yet another embodiment of the present invention, wherein a cleaning device 500 includes a main unit 502 and a removable cleaning receptacle 504. The main unit 502 includes first and second grooved rails 506, 508 that are sized to securely receive mated outwardly turned flanges 510, 512 of upper and lower portions 514, 516, respectively, of the cleaning receptacle 504. As seen specifically in FIG. 35, the cleaning receptacle 504 further includes an opening 518 that may be placed in fluid communication with a vacuum tube (not shown) of the main unit 502. As seen in FIG. 34, the cleaning receptacle 504 is inserted into the main unit 502 until projections 519 extending from the flanges 510, 512 engage walls defining notches 521 in the rails 506, 508. Alternatively, notches may be formed in the flanges 510, 512 and projections may be formed in the rails 506, 508. Preferably, the opening 518 is centered within the main unit 502 such that an articulating vacuum tube (not shown) in the main unit 502 is moved downward into contact with the opening 518 and seals the opening 518. During operation, the vacuum tube rotates the cleaning receptacle 504 by rotating the first and second grooved rails 506, 508, which form a disk-like area in a bottom area of the main unit 502.

The upper portion 514 includes three flexing arms 520a-520c that are similar or identical to the flexing arms 474. Piercing elements 522a-522c and 524a-524c similar or identical to the piercing elements 470a-470c and 472a-472c, respectively, are carried on lower surfaces 526a-526c of the flexing arms 520a-520c, respectively. Frangible sections (not shown but identical to the sections 478 described above) may be provided interconnecting ends of the flexing arms 520a-520c to the balance of the upper portion 514.

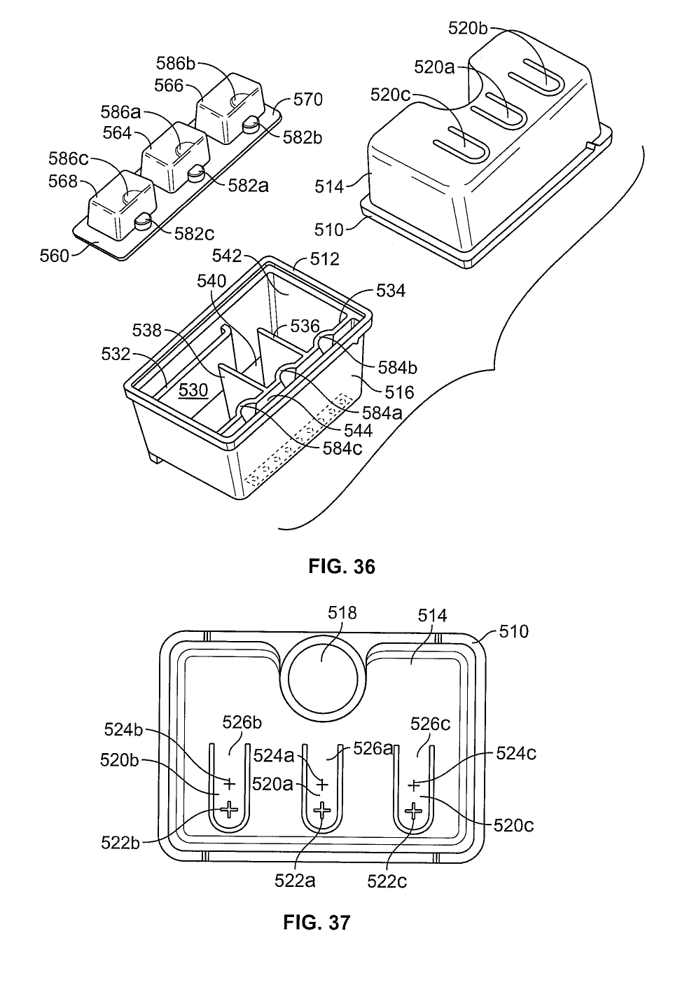

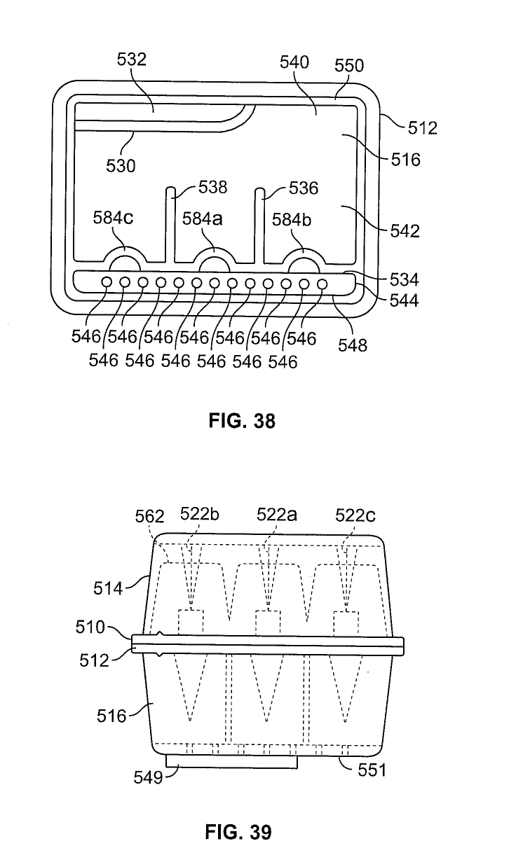

Referring next to FIGS. 36 and 38, the lower portion 516 includes a wall 530, defining an extraction slot 532, a first support rib 534 and second and third spaced support ribs 536, 538 extending transversely with respect to the first support rib 534. The first through third support ribs 534, 536, and 538 extend upwardly from a bottom surface 540 of the lower portion and define a main non-expandable compartment 542 and a fluid channel 544. A series of holes 546 are disposed at the bottom of the fluid channel 544 and extend fully through a bottom wall 548 of the cleaning receptacle 504. If desired, walls 549 (FIG. 39) defining a channel extension may be provided. Further if desired, bristles (not shown) may be provided on a lower surface 551 of the lower portion 516, as in the previous embodiments.

The lower portion 516 may have a stepped outer configuration in that the outwardly turned flange 512 may be disposed at an elevation slightly higher than an adjacent shoulder 550 extending about the main compartment 542 and the fluid channel 544. The shoulder 550 is preferably disposed at the same elevation as upper surfaces of the ribs 534, 536, and 538. Further, the upper surface of the wall 530 is preferably below the elevation of the shoulder 550.

Referring generally to FIGS. 36-39, an insert 560 is designed to be received in a compartment 562 of the upper portion 514. As seen in FIG. 36, the insert 560 includes three non-expandable compartments 564, 566, and 568, which, in the preferred embodiment, are joined together by webs of material. Preferably, as in the previous embodiment, the webs of material and the material forming the compartments are made of a thermoformed plastic material and/or a combination of a thermoformed plastic and aluminum foil covers and the insert 560 is light, flexible, and disposable after use. Also preferably in this embodiment, all of the compartments 564, 566, and 568 of the insert 560 are unitary with one another and with the webs of material so that the insert 560 comprises a single unit, although as in previous embodiments, this need not be the case. Still further, in the preferred embodiment, the compartments 564, 566, and 568 are prefilled with cleaning solution(s) and rinsing solution(s), the compartments 564, 566, and 568 of the insert 560 are sealed and the insert 560 is intended for one-time use.

The apparatus 500 of FIGS. 34-39 is prepared for use by removing the cleaning receptacle 504 from the main unit 502, separating the upper portion 514 of the cleaning receptacle 504 from the lower portion 516, placing the insert 560 onto the upper surfaces of the shoulder 550 and the ribs 534, 536, and 538 in the illustrated orientation, and replacing the upper portion 514 onto the lower portion 516 to capture portions 570 of the web of the insert 560 therebetween. In this regard, the upper and lower portion 514, 516 need not snap together or otherwise firmly mate together if the combined thicknesses of the flanges 510, 512 are just slightly less than the heights of the grooves in the rails 506, 508 so that no leakage of fluid occurs. Alternatively, as desired, the upper and lower portions 514, 516 may snap together or may otherwise be held together to provide a fluid-tight connection therebetween. The cleaning receptacle 504 is then inserted fully into the main unit 502.

In use, the apparatus undertakes the steps noted with respect to the previous embodiment(s). Specifically, the main unit includes at least one source of motive power, such as a solenoid (not shown) that moves downwardly into contact with the flexing arms 520a, 520b, and 520c to open the compartments 564, 566, and 568, with agitation and optional dwell steps between such opening steps. In this regard, the insert 570 is positioned in the cleaning receptacle 560 such that the piercing elements 522a, 522b, and 522c pierce fully through the insert 560 at piercing bosses 582a, 582b, and 582c. If necessary or desirable, the rib 534 may have curved recessed portions 584a, 584b, and 584c (FIGS. 36 and 38) that are sized to accept the ends of the piercing elements 522a, 522b, and 522c, respectively, when the flexing arms 520a, 520b, and 520c are moved downwardly. Further, the piercing elements 524a, 524b, and 524c pierce and create vent holes at piercing bosses 586a, 586b, and 586c, respectively, when the flexing arms 520a, 520b, and 520c are moved downwardly. When each of the compartments 564, 566, and 568 are so opened, fluid flows into the fluid channel and out through the holes 546. Liquid and/or other pick up of materials occurs through the slot defined by the optional walls 549 and the wall 530 into the main compartment 542. In this embodiment, a replaceable filter (not shown) may be disposed in the vacuum tube 110 of the device main body 62 to prevent any fluids from being pulled into the first motor 100.

Referring to FIG. 35A, a drive unit 600 is operatively disposed within the main unit 502 and a shaft 602 extends from and is rotated by the drive unit 600. Three cams 604a-604c extend from the shaft 602 at different angles (i.e., 30 degrees apart). The drive unit 600 rotates the shaft 602, thereby rotating the cams 604a-604c such that each cam 604a-604c sequentially moves into a position wherein the cam 604a-604c is in contact with a respective flexing arm 520a-520c of the cleaning receptacle 504. As seen in FIG. 35A, the cam 604b is preferably, although not necessarily, rotated clockwise into a position wherein the cam 604b is in contact with the flexing arm 520b, thereby depressing the flexing arm 520b and causing the piercing elements 522b, 524b to pierce the piercing bosses 582b, 586b, respectively. As the shaft 602 continues rotating, the cam 604b moves out of contact with the flexing arm 520b and the cam 604b moves into contact with the flexing arm 520a, depressing the flexing arm 520b and causing the piercing elements 522a, 524a to pierce the piercing bosses 582a, 586a, respectively. Still further, as the shaft 602 continues rotating, the cam 604b rotates out of contact with the flexing arm 520b and the cam 604c rotates into contact with the flexing arm 520c, causing the piercing elements 522c, 524c to pierce respective piercing bosses 582c, 586c. As the shaft continues rotating, all three cams 604a-604c rotate out of contact with the respective flexing arms 520a-520c to allow a user to remove the cleaning receptacle 504 and/or insert a new cleaning receptacle 504. Although the cams 604a-604c are depicted as being actuated in a specific order, the order can be changed as desired.

Although many of the elements of the embodiments of cleaning devices and cleaning receptacles as disclosed herein are depicted as plastic or metal, such elements may be made of alternative materials.

### INDUSTRIAL APPLICABILITY

The present invention comprises a device for cleaning a surface in a simple and effective manner without the need to actively participate in the cleaning process.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method of cleaning a surface, the method comprising the steps of:
applying a first fluid to the surface by feeding the first fluid from a unitary cleaning receptacle removably secured to a cleaning unit;
moving the unitary cleaning receptacle relative to the cleaning unit to agitate the first fluid;
applying a second fluid from the unitary cleaning receptacle to the surface;
capturing at least a portion of the first fluid and at least a portion of the second fluid in a recovery compartment of the unitary cleaning receptacle; and
removing the unitary cleaning receptacle from the cleaning unit.

2. The method of claim 1 further including the step of replacing the unitary cleaning receptacle with a further unitary cleaning receptacle.

3. The method of claim 1, wherein the step of moving the unitary cleaning receptacle relative to the cleaning unit includes the step of moving the unitary cleaning receptacle in a circular motion.

4. The method of claim 1, wherein the capturing step includes the step of applying a vacuum to cause at least a portion of the first fluid and at least a portion of the second fluid to be captured in the recovery compartment.

5. The method of claim 1, wherein the capturing step includes the step of absorbing the rinsing liquid and at least some of the cleaning solution.

6. The method of claim 1, wherein at least one of the applying steps includes the use of gravity to dispense the fluid(s) to a surface.

7. The method of claim 1, wherein at least one of the applying steps includes the use of pressure to dispense the fluid(s) to a surface.

8. The method of claim 1, wherein the first fluid is a cleaning solution and the second fluid is a rinsing liquid.

9. The method of claim 1, wherein the removing step includes the step of ejecting the unitary cleaning receptacle from the cleaning unit without the need for user contact with the cleaning receptacle.

10. The method of claim 1, further including the step of disposing of the unitary cleaning receptacle.

11. A cleaning receptacle, comprising:
a first non-expandable compartment for containing a first fluid;
a second non-expandable compartment for containing a second fluid, wherein the second compartment is integral with the first compartment; and
a third non-expandable compartment for receiving first and second fluids that are recovered from a surface;
wherein the cleaning receptacle is removably mounted on the cleaning unit.

12. The cleaning receptacle of claim 11, wherein the first fluid is a cleaning solution and the second fluid is a rinsing liquid.

13. The cleaning receptacle of claim 11, wherein the first and second compartments share a common wall that is rigid and the second and third compartments share a common wall that is rigid.

14. The cleaning receptacle of claim 11, in combination with a cleaning unit.

15. The cleaning receptacle of claim 14, further including an indicator thereon and wherein the cleaning unit includes a sensor configured to sense the indicator, such that the indicator provides an indication to the cleaning unit of the type of cleaning receptacle.

16. The cleaning receptacle of claim 15, wherein the cleaning unit implements functionality whereby upon sensing the type of cleaning receptacle, certain functions specific to the type of cleaning receptacle are enabled.

17. The cleaning receptacle of claim 14, wherein the cleaning receptacle is removably mounted on the cleaning unit by an annular lip disposed about the cleaning receptacle such that a catch mechanism disposed on the cleaning unit interacts with the lip to retain the cleaning receptacle on the cleaning unit.

18. A cleaning receptacle, comprising:
a first compartment for containing a first fluid;
a second compartment for containing a second fluid, wherein the second compartment shares a rigid common wall with the first compartment; and
a third compartment for receiving recovered first and second fluid, wherein the third compartment shares a rigid common wall with the second compartment.

19. The cleaning receptacle of claim 18, wherein the first and second compartments include first and second reservoirs containing the first and second fluids, respectively.

20. The cleaning receptacle of claim 18, wherein an actuating mechanism causes the first and second reservoirs to dispense the first and second fluids, respectively, therefrom.

21. The cleaning receptacle of claim 20, wherein the actuating mechanism includes a solenoid-operated sliding valve.

22. The cleaning receptacle of claim 20, wherein the actuating mechanism includes a tool that pierces the first and second reservoirs to allow the first and second fluids, respectively, to enter the first and second compartments respectively.

23. The cleaning receptacle of claim 20, wherein each of the first and second reservoirs includes a plurality of apertures in a bottom surface thereof such that the first and second fluids may be dispersed from the first and second compartments, respectively, onto a surface.

24. The cleaning receptacle of claim 18, in combination with a cleaning unit.

25. A cleaning unit, comprising:
a source of vacuum; and
a unitary cleaning receptacle defining first, second, and third compartments, each integral with the cleaning receptacle;
wherein the cleaning receptacle is removably mounted on the cleaning unit such that the unitary cleaning receptacle is in communication with the source of vacuum to draw fluids and dirt from a surface into the third compartment.

26. The cleaning unit of claim 25, wherein the first compartment receives a cleaning fluid and the second compartment receives a rinse fluid.

27. The cleaning unit of claim 25, wherein the unitary cleaning receptacle includes an agitator extending from a bottom surface thereof such that the agitator can aid in cleaning a surface.

28. The cleaning unit of claim 25, further including anchor posts extending from a bottom thereof to engage a surface to be cleaned such that, during cleaning, the cleaning unit remains relatively stable.

29. The cleaning unit of claim 25, further including at least one button for operating the cleaning unit and at least one indicator configured to indicate an operating mode of the cleaning unit.

30. The cleaning unit of claim 29, wherein the indicator is an LED.

31. The cleaning unit of claim 29, further including a display to provide user feedback regarding the operation of the cleaning unit.

32. The cleaning unit of claim 25, wherein the vacuum source draws fluids and dirt through an elongate opening in a bottom portion of the cleaning receptacle.

33. A cleaning receptacle, comprising:
a first compartment for containing a fluid;
a second compartment for receiving recovered fluid, wherein the second compartment is integral with the first compartment; and
an indicator disposed on the cleaning receptacle and configured to indicate the type of cleaning receptacle.

34. The cleaning receptacle of claim 33, further including a third compartment for containing a second fluid.

35. The cleaning receptacle of claim 34, wherein the first and third compartments include first and second reservoirs containing the first-named and the second fluids, respectively.

36. The cleaning receptacle of claim 35, wherein each of the first and third compartments includes a plurality of apertures in bottom portions thereof to disperse the first-named and second fluids respectively therefrom.

37. The cleaning receptacle of claim 33, further including an absorbent material disposed in the second compartment for absorbing fluids therein.

38. The cleaning receptacle of claim 33, in combination with a cleaning unit.

39. The cleaning receptacle of claim 38, wherein the cleaning unit includes a sensor configured to sense the indicator and the cleaning unit implements functionality whereby upon sensing the type of cleaning receptacle, certain functions specific to the type of cleaning receptacle are enabled.

40. The cleaning receptacle of claim 33, wherein the first and second compartments are connected to one another by a connecting web.

41. A system for cleaning surfaces, comprising:
a cleaning unit;
a first cleaning receptacle defining at least two compartments that are integral with the first receptacle, wherein the first cleaning receptacle is removably mounted within the cleaning unit and wherein one of the at least two compartments includes a first fluid specific to cleaning a first predetermined set of surface conditions; and
a second cleaning receptacle defining at least two integral compartments that are integral with the second receptacle, wherein the second cleaning receptacle is removably mounted within the cleaning unit and wherein one of the at least two compartments in the second cleaning receptacle includes a second fluid specific to cleaning a second predetermined set of surface conditions different from the first set of surface conditions.

42. The system of claim 41, further including a third cleaning receptacle defining at least two compartments that are integral with the third cleaning receptacle, wherein the third cleaning receptacle is removably mounted within the cleaning unit and wherein one of the compartments includes a third fluid specific to cleaning a third set of predetermined surface conditions different from the first and second sets of surface conditions.

43. The system of claim 41, wherein only one of the first and second cleaning receptacles may be mounted to the cleaning unit at a time.

44. The system of claim 41, wherein each of the first and second cleaning receptacles includes an indicator thereon such that a sensor on the cleaning unit senses the indicator to indicate to the cleaning unit the type of cleaning receptacle.

45. The system of claim 44, wherein the cleaning unit implements functionality whereby upon sensing the indicator, certain functions in the cleaning unit specific to the type of cleaning receptacle are enabled.

46. A cleaning receptacle, comprising:
first walls forming a receptacle body having a compartment for receipt of a cleaning solution therein, the walls further including at least one second wall defining an aperture configured to accept a member of a vacuum cleaning apparatus therein.

47. The cleaning receptacle of claim 46, wherein the walls are rigid.

48. The cleaning receptacle of claim 46, wherein the compartment is accessible through a cover and further in combination with an additional receptacle body that is inserted into the compartment through the cover wherein the additional receptacle body has non-expanding walls defining a further compartment.

49. The cleaning receptacle of claim 45, in combination with a vacuum cleaning apparatus having a member for communicating with the cleaning receptacle.

50. The cleaning receptacle of claim 49, wherein the member communicates with the aperture of the cleaning receptacle and rotates the cleaning apparatus.

51. A method of cleaning a surface, the method comprising the steps of:
applying a first fluid to the surface by feeding the first fluid from a cleaning receptacle removably secured to a cleaning unit;
moving the cleaning receptacle relative to the cleaning unit to agitate the cleaning solution;
applying a second fluid to the surface;
capturing at least a portion of the first fluid and at least a portion of the second fluid in a recovery compartment associated with the cleaning receptacle;
removing the cleaning receptacle from the cleaning unit; and
replacing the cleaning receptacle with a further unitary cleaning receptacle.

52. A cleaning receptacle, comprising:
a first compartment for containing a first fluid;
a second compartment for containing a second fluid, wherein the second compartment is connected by a web to the first compartment; and
a third compartment for receiving recovered first and second fluid.

53. The cleaning receptacle of claim 52, wherein the third compartment is connected to at least one of the first and second compartments.

54. The cleaning receptacle of claim 52, wherein the first, second, and third compartments are disposed together in a fourth compartment.
